(19) United States
(12) Patent Application Publication
(10) Pub. No.: US 2026/0089407 A1
(43) Pub. Date: Mar. 26, 2026

(54) PHOTOELECTRIC CONVERSION DEVICE

(71) Applicant: CANON KABUSHIKI KAISHA, Tokyo (JP)

(72) Inventor: DAISUKE KOBAYASHI, Kanagawa (JP)

(21) Appl. No.: 19/272,870

(22) Filed: Jul. 17, 2025

(30) Foreign Application Priority Data
Jul. 25, 2024 (JP) 2024-120289

(51) Int. Cl. H04N 25/65; H04N 25/40; H04N 25/703; H04N 25/77

(52) U.S. Cl. CPC H04N 25/65; H04N 25/703; H04N 25/77; H04N 25/40

(57) ABSTRACT

A photoelectric conversion device includes a pixel array in which pixels are arranged to form rows and columns, and a scanning circuit configured to perform scanning for sequentially selecting a row in which the pixels output signals, from among the rows. A first pixel arranged in a first region of the pixel array outputs a signal based on incident light. A second pixel arranged in a second region of the pixel array does not output a signal based on incident light. In a period in which pixels in one row of the pixel array output signals, a reset operation is started or ended. In a period from a start of one scan to a start of the next scan, the number of times of the reset operation performed in the second pixel is greater than the number of times of the reset operation performed in the first pixel.

### BACKGROUND

### Field of the Technology

The aspect of the embodiments relates to a photoelectric conversion device.

### Description of the Related Art

Japanese Patent Laid-Open No. 2015-177349 discloses a photoelectric conversion device including a plurality of pixels. In the photoelectric conversion device of Japanese Patent Laid-Open No. 2015-177349, reset of a photoelectric conversion unit of a pixel and readout of charge from the photoelectric conversion unit are simultaneously performed among the plurality of pixels. Such an operation of the photoelectric conversion device is referred to as a global electronic shutter operation.

### SUMMARY

According to an aspect of the embodiments, there is provided a photoelectric conversion device including a pixel array in which a plurality of pixels are arranged to form a plurality of rows and a plurality of columns, each of the plurality of pixels including a charge accumulation unit configured to accumulate charge, a discharge transistor configured to perform a reset operation to discharge the charge accumulated in the charge accumulation unit, a holding unit configured to hold transferred charge, an amplification unit configured to output a signal based on the transferred charge, a first transfer transistor configured to transfer the charge from the charge accumulation unit to the holding unit, and a second transfer transistor configured to transfer the charge transferred by the first transfer transistor to the amplification unit, and a scanning circuit configured to perform scanning for sequentially selecting a row in which the pixels output signals, from among the plurality of rows. A first pixel arranged in a first region of the pixel array outputs a signal based on incident light. A second pixel arranged in a second region of the pixel array does not output a signal based on incident light. In a period in which pixels in one row of the pixel array output signals, the reset operation by the discharge transistor is started or ended. In a period from a start of one scan to a start of the next scan, number of times of the reset operation performed in the second pixel is greater than number of times of the reset operation performed in the first pixel.

Features of the disclosure will become apparent from the following description of embodiments with reference to the attached drawings. The following description of embodiments is described by way of example.

### BRIEF DESCRIPTION OF THE DRAWINGS

FIG. 1 is a diagram illustrating a configuration of a photoelectric conversion device according to a first embodiment.

FIG. 2 is a diagram illustrating an equivalent circuit of a pixel according to the first embodiment.

FIG. 3 is a diagram illustrating an equivalent circuit of a column circuit according to the first embodiment.

FIG. 4 is a diagram illustrating drive timings of the photoelectric conversion device according to a comparative example of the first embodiment.

FIG. 5 is a diagram illustrating regions in a pixel array according to the first embodiment.

FIG. 6 is a diagram illustrating drive timings of the photoelectric conversion device according to the first embodiment.

FIG. 7 is a diagram illustrating a modification of the equivalent circuit of the column circuit according to the first embodiment.

FIG. 8A and FIG. 8B are diagrams illustrating driving of pixels and holding of data in memories according to the first embodiment.

FIG. 9 is a diagram illustrating an equivalent circuit of a pixel according to a second embodiment.

FIG. 10 is a diagram illustrating drive timings of the photoelectric conversion device according to the second embodiment.

FIG. 11 is a diagram illustrating a modification of drive timings of the photoelectric conversion device according to the second embodiment.

FIG. 12 is a diagram illustrating an equivalent circuit of the column circuit according to the second embodiment.

FIG. 13A and FIG. 13B are diagrams illustrating driving of pixels and holding of data in memories according to the second embodiment.

FIG. 14A and FIG. 14B are diagrams illustrating a modification of driving of the pixels and holding of data in the memories according to the second embodiment.

FIG. 15A and FIG. 15B are diagrams illustrating a modification of driving of the pixels and holding of data in the memories according to the second embodiment.

FIG. 16 is a diagram illustrating an equivalent circuit of the column circuit according to a third embodiment.

FIG. 17 is a diagram illustrating drive timings of the photoelectric conversion device according to a fourth embodiment.

FIG. 18 is a diagram illustrating regions in a pixel array according to the fourth embodiment.

FIG. 19 is a diagram illustrating a procedure of signal processing according to the fourth embodiment.

FIG. 20 is a diagram illustrating a modification of the procedure of the signal processing according to the fourth embodiment.

FIG. 21 is a diagram illustrating a modification of the regions in the pixel array according to the fourth embodiment.

FIG. 22 is a diagram illustrating a photoelectric conversion device and a signal processing device according to a fifth embodiment.

FIG. 23 is a diagram illustrating a procedure of signal processing according to the fifth embodiment.

FIG. 24 is a block diagram of equipment according to a sixth embodiment.

FIG. 25A and FIG. 25B are block diagrams of equipment according to a seventh embodiment.

### DESCRIPTION OF THE EMBODIMENTS

In a photoelectric conversion device in which a global electronic shutter operation is performed, a change in a potential of a control line that propagates a control signal for the global electronic shutter operation may propagate to another wiring or another element via a parasitic capacitance. In addition, a transient change in the potential of a reference potential line caused by the global electronic shutter operation may propagate to another wiring or another element. As described above, noise may be generated by the global electronic shutter operation. The disclosure relates to a photoelectric conversion device capable of reducing the influence of noise generated by the global electronic shutter operation.

Hereinafter, embodiments of the disclosure will be described with reference to the drawings. The same or corresponding elements are denoted by the same reference numerals throughout the several drawings, and the description thereof may be omitted or simplified.

In the first to fifth embodiments described below, an imaging device will be mainly described as an example of a photoelectric conversion device. However, the photoelectric conversion device in each embodiment is not limited to the imaging device, and can be applied to other photodetection devices based on photoelectric conversion. Examples of other photodetection devices include a ranging device and a photometric device. The ranging device may be, for example, a focus detection device, a distance measuring device using time-of-flight (TOF), or the like. The photometric device may measure the amount of light incident on the device.

Note that transistors described in the following description are N-type transistors unless otherwise specified. However, transistors that can be employed in the following embodiments are not limited to N-type transistors, and P-type transistors may be employed. In that case, the potentials of the gate, the source, and the drain of the transistor can be changed as appropriate. For example, in a transistor operated as a switch, the level (low level or high level) of the potential supplied to the gate can be reversed with respect to the description in the embodiments.

### First Embodiment

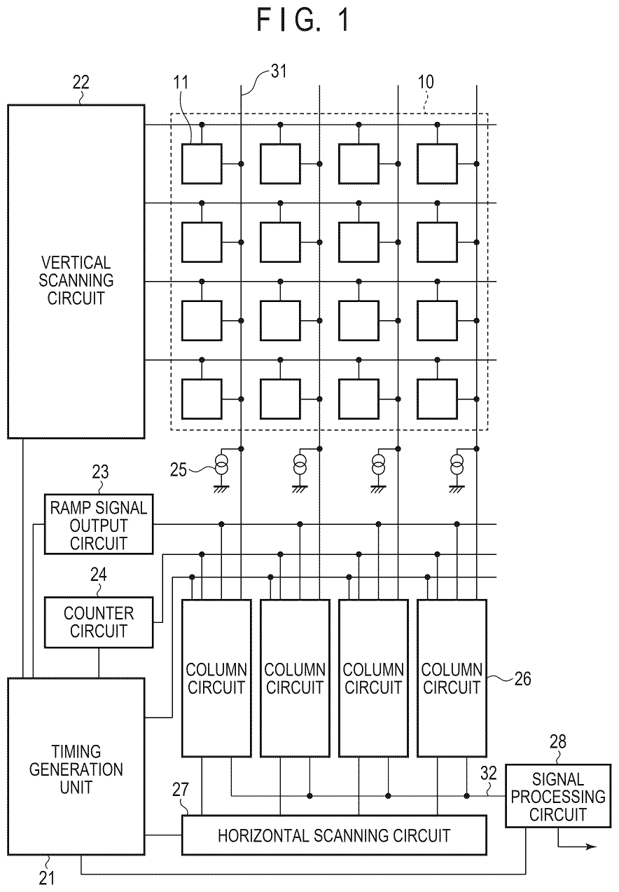

FIG. 1 is a diagram illustrating a configuration of a photoelectric conversion device according to one embodiment. The photoelectric conversion device includes a pixel array 10, a timing generation unit 21, a vertical scanning circuit 22, a ramp signal output circuit 23, a counter circuit 24, a plurality of current sources 25, a plurality of column circuits 26, a horizontal scanning circuit 27, and a signal processing circuit 28. The timing generation unit 21 supplies control signals to the vertical scanning circuit 22, the ramp signal output circuit 23, the counter circuit 24, the plurality of column circuits 26, the horizontal scanning circuit 27, and the signal processing circuit 28.

As illustrated in FIG. 1, the pixel array 10 includes a plurality of pixels 11 arranged in a plurality of rows and a plurality of columns. FIG. 1 illustrates an example in which 16 pixels 11 are arranged in four rows and four columns for simplification, but in an actual photoelectric conversion device, several tens of millions of pixels 11 may be arranged in the pixel array 10. The photoelectric conversion device of FIG. 1 is a so-called CMOS image sensor.

In the photoelectric conversion device, a vertical output line 31 is arranged corresponding to each column of the plurality of pixels 11. Each of the plurality of pixels 11 may include a photoelectric conversion unit that generates charge by photoelectric conversion. The signals output from the pixels 11 in each column are output to the corresponding vertical output line 31. A detailed configuration of the pixel 11 will be described later. The current source 25 is electrically connected to the corresponding vertical output line 31. The current source 25 supplies a current to the vertical output line 31. Although the vertical output line 31 is connected to the plurality of pixels 11 in one column in FIG. 1, the connection between the vertical output line 31 and the pixels 11 is not limited thereto. For example, instead of the vertical output line 31, an output line connected to a plurality of pixels 11 in one row may be arranged.

The vertical scanning circuit 22 outputs a control signal for controlling the pixels 11 for each row via a control line. The vertical scanning circuit 22 sequentially selects the pixels 11 in a row basis, and performs scanning for outputting signals from the selected pixels 11 to the vertical output lines 31.

The column circuit 26 is arranged corresponding to each column of the pixels 11. The signal output from the pixel 11 of each column is input to the column circuit 26 in the corresponding column via the vertical output line 31 in the corresponding column. The column circuit 26 amplifies the signal output from the pixel 11 and performs analog-to-digital conversion (AD conversion).

The ramp signal output circuit 23 outputs a ramp signal VRAMP used as a reference signal in AD conversion to the column circuit 26. The ramp signal VRAMP is a signal whose voltage changes with time. In the embodiment, the ramp signal VRAMP has a constant slope (a voltage change amount per unit time), but the slope of the ramp signal VRAMP may change in the middle of the voltage change. The ramp signal VRAMP whose slope changes in the middle of the voltage change includes a signal in which the voltage of the ramp signal VRAMP changes stepwise. The ramp signal output circuit 23 may output a plurality of types of ramp signals VRAMP having different slopes. The ramp signal output circuit 23 may generate the ramp signal VRAMP, and a circuit (not illustrated) different from the ramp signal output circuit 23 may generate the ramp signal VRAMP.

The counter circuit 24 outputs a count signal CNT used for AD conversion to the column circuits 26. The count signal CNT indicates an elapsed time from a time point when the ramp signal VRAMP starts changing with respect to time. The count signal CNT is a signal obtained by counting a clock pulse signal supplied from a clock pulse supply unit (not illustrated). Although one counter circuit 24 is provided in common to the plurality of column circuits 26 in FIG. 1, the plurality of counter circuits 24 may be provided so as to respectively correspond to the column circuits 26.

The horizontal scanning circuit 27 sequentially selects the plurality of column circuits 26. The column circuit 26 outputs the AD-converted signal to the signal processing circuit 28 via the horizontal output line 32. The signal processing circuit 28 processes the signal input from the column circuit 26 and outputs the processed signal to the outside of the photoelectric conversion device.

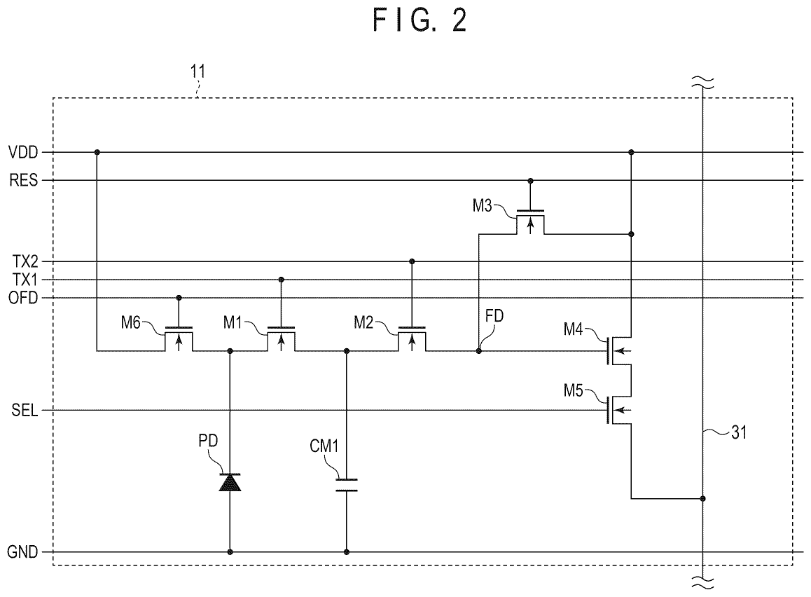

FIG. 2 is a diagram illustrating an equivalent circuit of the pixel 11 according to the embodiment. The pixel 11 includes a photoelectric conversion unit PD, a holding unit CM1, a first transfer transistor M1, a second transfer transistor M2, a reset transistor M3, an amplification transistor M4, a selection transistor M5, and a discharge transistor M6. The first transfer transistor M1, the second transfer transistor M2, the reset transistor M3, the amplification transistor M4, the selection transistor M5, and the discharge transistor M6 may typically be MOS transistors.

The photoelectric conversion unit PD is a photoelectric conversion element that generates and accumulates charge based on incident light by photoelectric conversion. The photoelectric conversion unit PD is typically a photodiode. Another example of the photoelectric conversion unit PD is a photoelectric conversion film. In the following description, it is assumed that the photoelectric conversion unit PD is a photodiode having an anode and a cathode.

The anode of the photoelectric conversion unit PD is connected to a ground line having a ground potential GND. The cathode of the photoelectric conversion unit PD is connected to a source of the first transfer transistor M1 and a source of the discharge transistor M6. A drain of the discharge transistor M6 is connected to a power supply line having a power supply potential VDD. A drain of the first transfer transistor M1 is connected to a source of the second transfer transistor M2 and the holding unit CM1. The holding unit CM1 has an electrostatic capacitance that holds the charge transferred from the photoelectric conversion unit PD.

A drain of the second transfer transistor M2 is connected to a source of the reset transistor M3 and a gate of the amplification transistor M4. A connection node of the drain of the second transfer transistor M2, the source of the reset transistor M3, and the gate of the amplification transistor M4 is a floating diffusion FD. The floating diffusion FD has a parasitic capacitance parasitizing impurity diffusion layers, wirings, gate electrodes, and the like constituting these transistors, and the holding unit CM1 holds the charge transferred from the photoelectric conversion unit PD.

A drain of the reset transistor M3 and a drain of the amplification transistor M4 are connected to a power supply line having the power supply potential VDD. A source of the amplification transistor M4 is connected to a drain of the selection transistor M5. A source of the selection transistor M5 is connected to the vertical output line 31.

In each row of the pixel array 10, a plurality of control lines are arranged extending in the row direction. The vertical scanning circuit 22 supplies control signals to gates of the plurality of transistors in the pixel 11 via the plurality of control lines. A control signal TX1 is supplied to a gate of the first transfer transistor M1. A control signal TX2 is supplied to a gate of the second transfer transistor M2. A control signal RES is supplied to a gate of the reset transistor M3. A control signal SEL is supplied to a gate of the selection transistor M5. A control signal OFD is supplied to a gate of the discharge transistor M6.

When the first transfer transistor M1 is controlled to be turned on by the control signal TX1, the charge generated and accumulated in the photoelectric conversion unit PD is transferred to the holding unit CM1. The holding unit CM1 holds the charge transferred from the photoelectric conversion unit PD. When the second transfer transistor M2 is controlled to be turned on by the control signal TX2, the charge held in the holding unit CM1 is transferred to the floating diffusion FD. When the reset transistor M3 is controlled to be turned on by the control signal RES, the potential of the floating diffusion FD is reset. When the selection transistor M5 is controlled to be turned on by the control signal SEL, a signal is output from the amplification transistor M4 in the corresponding row to the vertical output line 31. At this time, the amplification transistor M4 and the current source 25 connected to the vertical output line 31 constitute a source follower circuit that outputs a signal corresponding to the charge transferred to the floating diffusion FD, thereby functioning as an amplification unit. When the discharge transistor M6 is controlled to be turned on by the control signal OFD, the charge accumulated in the photoelectric conversion unit PD is discharged, and the potential of the cathode of the photoelectric conversion unit PD is reset.

With these configurations, a configuration is realized in which charge is generated in the photoelectric conversion unit PD and accumulated in the photoelectric conversion unit PD while charge is held in the holding unit CM1. Accordingly, the photoelectric conversion device can perform the driving of the global electronic shutter method in which the start time and the end time of the charge accumulation in the plurality of photoelectric conversion units PD in the pixel array 10 are matched. The start of the charge accumulation by the global electronic shutter method can be realized, for example, by simultaneously controlling the plurality of discharge transistors M6 in the pixel array 10 from the on state to the off state to end the discharging. In addition, the end of the charge accumulation by the global electronic shutter method can be realized, for example, by simultaneously controlling the plurality of first transfer transistors M1 in the pixel array 10 from the off state to the on state and controlling them to be the off state again to complete the charge transfer.

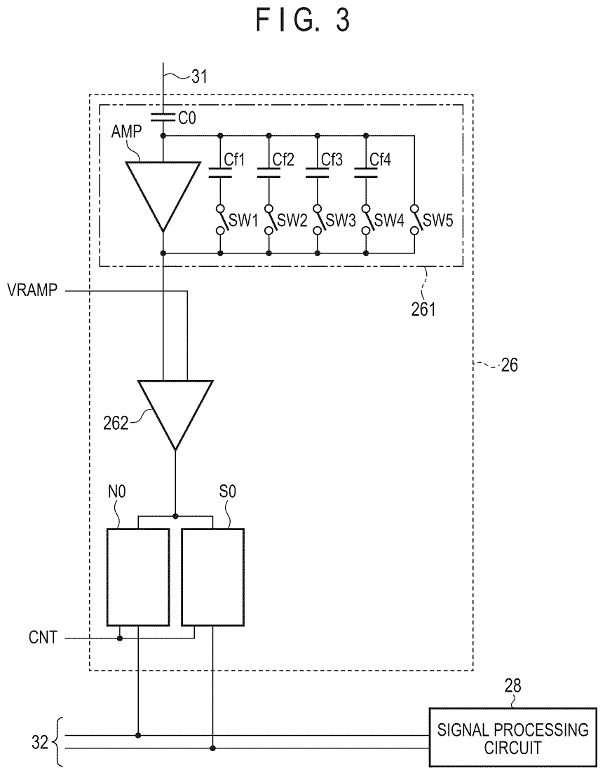

FIG. 3 is a diagram illustrating an equivalent circuit of the column circuit 26 according to the embodiment. The column circuit 26 includes a column amplifier 261, a comparator 262, and memories N0 and S0. The column amplifier 261 includes an amplifier AMP, an input capacitor C0, feedback capacitors Cf1, Cf2, Cf3, and Cf4, and switches SW1, SW2, SW3, SW4, and SW5. Each of the switches SW1, SW2, SW3, SW4, and SW5 may be controlled to be turned on or off by control signals output from the timing generation unit 21.

The vertical output line 31 is connected to a first terminal of the input capacitor C0. A second terminal of the input capacitor C0 is connected to an input terminal of the amplifier AMP, first terminals of the feedback capacitors Cf1, Cf2, Cf3, and Cf4, and a first terminal of the switch SW5. Second terminals of the feedback capacitors Cf1, Cf2, Cf3, and Cf4 are connected to first terminals of the switches SW1, SW2, SW3, and SW4, respectively. Second terminals of the switches SW1, SW2, SW3, SW4, and SW5 are connected to an output terminal of the amplifier AMP and a first input terminal of the comparator 262. The ramp signal VRAMP is input from the ramp signal output circuit 23 to a second input terminal of the comparator 262.

An output terminal of the comparator 262 is connected to first input terminals of the memories N0 and S0. The count signal CNT is input from the counter circuit 24 to second input terminals of the memories N0 and S0. Output terminals of the memories N0 and S0 are connected to the signal processing circuit 28 via the horizontal output line 32. The horizontal output line 32 includes two wirings, and digital signals output from the memories N0 and S0 are input to the signal processing circuit 28 via individual wirings.

The signal output from the pixel 11 is input to the column amplifier 261 via the vertical output line 31. The column amplifier 261 is an amplifier circuit having a variable gain. Assuming that a combined capacitance of the feedback capacitors that are enabled among the feedback capacitors Cf1, Cf2, Cf3, and Cf4 on the feedback path of the amplifier AMP is Cf, the gain of the column amplifier 261 is determined by C0/Cf, which is a ratio of the capacitance value of the input capacitor C0 to the combined capacitance Cf. The combined capacitance Cf of the feedback capacitors is controlled by the switches SW1, SW2, SW3, and SW4. The switch SW5 resets the column amplifier 261 to a predetermined state by short-circuiting the input terminal and the output terminal of the amplifier AMP. The gain of the column amplifier 261 may be either amplification or attenuation. For example, a part of the plurality of gains that can be set in the column amplifier 261 may be amplification and the other part may be attenuation, and in this case, the column amplifier 261 may also be referred to as an amplification circuit.

An output signal of the column amplifier 261 is input to the first input terminal of the comparator 262, and the ramp signal VRAMP is input to the second input terminal of the comparator 262. The comparator 262 is a comparison circuit that compares the potential of the output signal of the column amplifier 261 with the potential of the ramp signal VRAMP and outputs a comparison result signal. More specifically, the comparator 262 outputs a low-level comparison result signal when the potential of the ramp signal VRAMP is lower than the potential of the output signal of the column amplifier 261. When the potential of the ramp signal VRAMP is equal to or higher than the potential of the output signal of the column amplifier 261, the comparator 262 outputs a high-level comparison result signal. The relationship between the magnitude of the input signals to the comparator 262 and the level of the comparison result signal is merely an example, and may be reversed.

The comparison result signal is input to the first input terminals of the memories N0 and S0. In addition, the count signal CNT indicating an elapsed time from a time point when the ramp signal VRAMP starts changing with respect to time is input to the second input terminals of the memories N0 and S0. The memories N0 and S0 hold the count signal CNT supplied from the counter circuit 24 at the timing when the comparison result signal changes from the low level to the high level.

A digital signal (N-signal) of the reset level of the floating diffusion FD is held in the memory N0. The digital signal also includes a component of the characteristic variation of each column circuit 26. The memory S0 holds a digital signal (S-signal) at a level after the charge is transferred from the holding unit CM1 to the floating diffusion FD.

The digital signals held in the memories N0 and S0 are output to the signal processing circuit 28 via the horizontal output line 32 in accordance with the control signal from the horizontal scanning circuit 27. The signal processing circuit 28 performs correlated double sampling processing of subtracting the digital signal held in the memory N0 from the digital signal held in the memory S0. Accordingly, the signal processing circuit 28 can generate a signal in which a noise component generated at the time of resetting the floating diffusion FD is reduced.

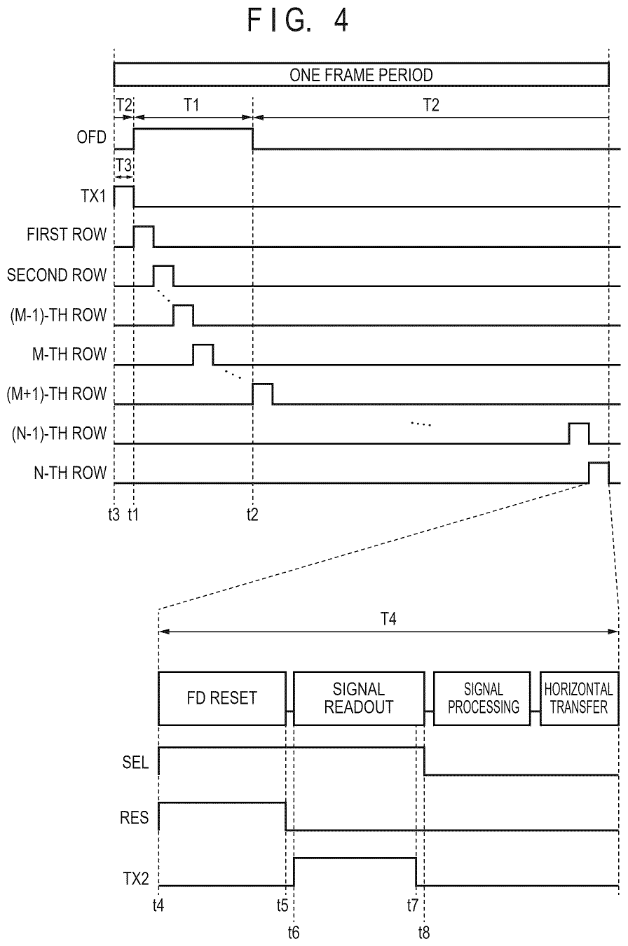

FIG. 4 is a diagram illustrating drive timings of the photoelectric conversion device according to a comparative example of the embodiment. Prior to the description of the drive timings of the photoelectric conversion device of the embodiment, a comparative example of the embodiment will be described with reference to FIG. 4.

FIG. 4 illustrates timings of potential changes of the control signals OFD, TX1, SEL, RES, and TX2 in one frame period. Further, “first row” to “N-th row” in FIG. 4 indicate timings of reading sequentially performed for each row of the pixel array 10. Each transistor is turned on in a period in which the level of the signal illustrated in FIG. 4 is at a high level, and is turned off in a period in which the level of the signal is at a low level. For the control signals OFD and TX1, common pulses are input to all the pixels 11 in the pixel array 10. For the control signals SEL, RES, and TX2, the pulses illustrated in FIG. 4 are sequentially input for each row in the pixel array 10.

At time t1, the control signal OFD changes from the low level to the high level. As a result, the discharge transistor M6 is turned on, the charge of the photoelectric conversion unit PD is discharged, and the photoelectric conversion unit PD is reset to a potential corresponding to the power supply potential VDD. That is, the time t1 is the start time of the reset operation. At time t2, the control signal OFD changes from the high level to the low level. As a result, the discharge transistor M6 is turned off. That is, the time t2 is the end time of the reset operation. As described above, a period T1 from the time t1 to the time t2 is a period in which the reset operation of the photoelectric conversion unit PD is performed.

In a period T2 after the time t2, the charge is accumulated in the photoelectric conversion unit PD by the incident light. That is, the time t2 is the start time of the charge accumulation operation, and the period T2 is the charge accumulation period in the photoelectric conversion unit PD.

At time t3 of the next frame period, the control signal TX1 changes from the low level to the high level. Accordingly, the first transfer transistor M1 is turned on, and the charge accumulated in the photoelectric conversion unit PD in the period T2 is transferred to the holding unit CM1. That is, the time t3 is the start time of the transfer operation. At the time t1, the control signal TX1 changes from the high level to the low level. As a result, the first transfer transistor M1 is turned off. That is, the time t1 is the end time of the transfer operation. The time t1 is also the end time of the charge accumulation in the photoelectric conversion unit PD. As described above, a period T3 from the time t3 to the time t1 is a period in which the transfer operation from the photoelectric conversion unit PD to the holding unit CM1 is performed. The period T2 from the time t2 to the time t1 of the next frame period is the charge accumulation period in the photoelectric conversion unit PD. The charge generated in the photoelectric conversion unit PD in the period after the period T3 is discharged through the discharge transistor M6, and thus does not contribute to the output signal of the photoelectric conversion device.

Although the period T3 is set at the beginning of one frame period in FIG. 4, the embodiment is not limited thereto. The period T3 may be set from before reading of each row is completed to before reading starts next. For example, the period T3 may be set at the end of one frame period.

As described above, the control signals OFD and TX1 collectively control the plurality of pixels 11. Therefore, the start time of the charge accumulation period in the photoelectric conversion unit PD is the same in each of the plurality of pixels 11. The end time of the charge accumulation period in the photoelectric conversion unit PD is also the same in each of the plurality of pixels 11. That is, the photoelectric conversion device of the embodiment can perform the global electronic shutter operation in which the charge accumulation periods of the plurality of pixels 11 coincide with each other.

Next, the readout timing of each row of the pixel array 10 will be described. FIG. 4 illustrates details of a period T4, which is a readout period of the N-th row. The operations of the first row to the (N−1)-th row are the same as those of the N-th row.

At time t4, the control signal SEL changes from the low level to the high level. Accordingly, the selection transistor M5 of the pixel 11 in the row to be read is turned on, and a signal is output from the amplification transistor M4 of the pixel 11 in the row to be read to the vertical output line 31.

At the time t4, the control signal RES changes from the low level to the high level. As a result, the reset transistor M3 of the pixel 11 in the row to be read is turned on, and the potential of the floating diffusion FD is reset to a potential corresponding to the power supply potential VDD.

Thereafter, at time t5, the control signal RES changes from the high level to the low level. As a result, the reset transistor M3 of the pixel 11 in the row to be read is turned off, and the reset of the floating diffusion FD is canceled. Therefore, a period from the time t4 to the time t5 is a reset period of the floating diffusion FD. After the cancelling of the reset at the time t5, a signal (noise signal) based on the potential of the reset level of the floating diffusion FD can be read. The noise signal may be used for the correlated double sampling processing.

At time t6, the control signal TX2 changes from the low level to the high level. As a result, the second transfer transistor M2 of the pixel 11 in the row to be read is turned on, and the charge held in the holding unit CM1 is transferred to the floating diffusion FD.

At time t7, the control signal TX2 changes from the high level to the low level. As a result, the second transfer transistor M2 of the pixel 11 in the row to be read is turned off, and the charge transfer from the holding unit CM1 to the floating diffusion FD is ended. After the charge transfer from the time t6 to the time t7 ends, a signal based on the potential of the floating diffusion FD after the charge transfer is read.

At time t8, the control signal SEL changes from the high level to the low level. Accordingly, the selection transistor M5 of the pixel 11 of the row to be read is turned off, and the signal output from the amplification transistor M4 of the pixel 11 of the row to be read to the vertical output line 31 is stopped.

After the time t8, signal processing such as AD conversion is performed in the column circuit 26, and the digital signals are held in the memories N0 and S0. Thereafter, horizontal transfer for transferring the digital signals from the column circuit 26 to the signal processing circuit 28 is performed.

At the start of the reset operation at the time t1, the control signal OFD is changed from the low level to the high level, and the discharge transistor M6 is turned on in all the pixels 11. The potential change in the operation can be propagated to another wiring or another transistor through a parasitic capacitance between wirings and a parasitic capacitance between elements. At the end of the reset operation at the time t2, the control signal OFD is changed from the high level to the low level, and the discharge transistor M6 is turned off in all the pixels 11. The potential change in the operation can be propagated to another wiring or another transistor through a parasitic capacitance between wirings and a parasitic capacitance between elements. At the time t1 and the time t2, for example, the potential of the ground line, the potential of the power supply line, and the potential of the vertical output line 31 may transiently fluctuate due to these factors.

The potential fluctuation causes, for example, fluctuations in the potentials of the drain, the source, and the back gate of the amplification transistor M4. The potential fluctuation of each terminal of the amplification transistor M4 is superimposed as noise on the output signal when the signal is output from the amplification transistor M4 to the vertical output line 31. As described above, the potential fluctuation of the control signal for the global electronic shutter operation may become a noise source for the output signal.

At least one of the start of the reset operation at the time t1 and the end of the reset operation at the time t2 may overlap the period of reading signals from the pixels 11 in a certain row. In the example of FIG. 4, the start of the reset operation at the time t1 overlaps the readout of the first row, and the end of the reset operation at the time t2 overlaps the readout of the (M+1)-th row. Therefore, when reading the first row and the (M+1)-th row, noise generated by the start of the reset operation and the end of the reset operation may be superimposed on the output signals. When signals output from the photoelectric conversion device are used to generate an image, stripes are generated in the horizontal direction of the generated image, and the image quality may be degraded. Since the stripes in the horizontal direction are easily visually recognized, reduction of such noise may be required.

In order to solve this issue, it is conceivable that the start of the reset operation at the time t1 and the end of the reset operation at the time t2 do not overlap with the readout period. However, when this method is applied, a decrease in frame rate may occur due to a read operation including a standby time in consideration of a reset operation. In addition, there is a possibility that it is necessary to secure a time for which transient fluctuations of the potential of the ground line, the potential of the power supply line, and the potential of the vertical output line 31 settle, and in this case, a further decrease in frame rate may occur.

In addition, in the above-described method, the constraint of the setting of the period T2 in which the charge accumulation operation is performed in the photoelectric conversion unit PD is large. For example, the length of the period of the charge accumulation operation in the photoelectric conversion unit PD may be short. In this case, continuity of the object between a plurality of consecutive frames may decrease. For example, when the output signals of the photoelectric conversion device is used to generate a moving image, the motion of the object in the moving image may be discontinuous, and the quality of the moving image may be degraded.

As described above, it is found that it may be an issue to suppress a decrease in image quality at the time of the reset operation for the global electronic shutter operation without increasing the constraints on the timings of the periods T1 and T2. Hereinafter, an example of a configuration and an operation of a photoelectric conversion device capable of coping with the above-described issue will be described.

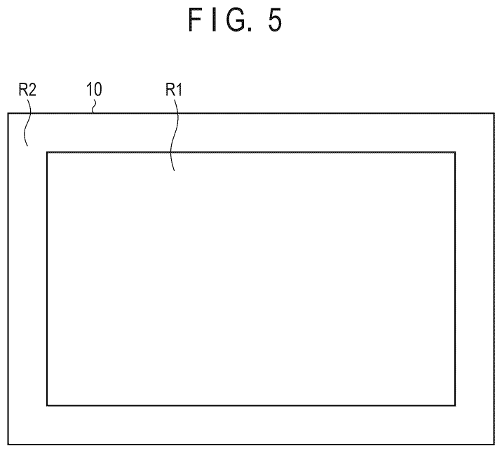

FIG. 5 is a diagram illustrating regions in the pixel array 10 according to the embodiment. The pixel array 10 has an effective pixel region R1 (first region) and an optical black (OB) pixel region R2 (second region). The effective pixel region R1 includes pixels 11 (effective pixels) that output signals based on incident light as illustrated in FIG. 2. That is, the pixel 11 (first pixel) in the effective pixel region R1 includes a photoelectric conversion element that generates charge according to incident light. Although the OB pixel region R2 includes pixels that have the same circuit configuration as that of the pixel 11 in FIG. 2, the photoelectric conversion unit PD is covered with a light shielding film, and light is not incident on the photoelectric conversion unit PD. As a result, the pixels 11 (OB pixels) in the OB pixel region R2 output signals that are not based on incident light. That is, although the pixel 11 (second pixel) in the OB pixel region R2 includes the photoelectric conversion element having the same element structure as that in the effective pixel region R1, the photoelectric conversion element is shielded from light. The output signal of the pixel 11 in the OB pixel region R2 can be used to correct noise.

The pixel array 10 may include a dummy pixel region in which dummy pixels not including the photoelectric conversion unit PD are arranged. In other words, a dummy element not including a photoelectric conversion element is arranged in the dummy pixel region. In the processing described below, processing performed on the pixels 11 in the OB pixel region R2 can be replaced with processing performed on the dummy pixels.

The photoelectric conversion element in the effective pixel has a function of generating and accumulating charge according to incident light, and the photoelectric conversion element shielded from light in the OB pixel and the dummy element in the dummy pixel have a function of generating and accumulating charge generated by noise. That is, each of the photoelectric conversion element in the effective pixel, the photoelectric conversion element shielded from light in the OB pixel, and the dummy element in the dummy pixel functions as a charge accumulation unit, and a signal can be read out by an operation corresponding to the period T4 in FIG. 4.

In FIG. 4, it is assumed that a range from the first row to the M-th row is the OB pixel region R2, and a range from the (M+1)-th row to the N-th row is the effective pixel region R1. In this case, the noise generated by the start of the reset operation and the end of the reset operation greatly affects the output signals particularly when the noise overlaps with the readout of the effective pixel region R1. Therefore, for example, when the start timing of the reset operation at the time t1 is set to a period between the readout of the first row and the readout of the M-th row, the influence of the start of the reset operation on the output signal is reduced. However, the end of the reset operation at the time t2 is to be set to any timing from the readout of the first row to the readout of the N-th row from the viewpoint of securing the length of the period T2 in which the charge accumulation is performed. That is, there is a case where the end of the reset operation at the time t2 has to overlap with the readout of the effective pixel region R1. In the example of the readout method of FIG. 4, the end of the reset operation at the time t2 overlaps the readout of the (M+1)-th row. Therefore, since the output signal of the (M+1)-th row may be affected by noise due to the end of the reset operation, a horizontal stripe may be generated in a portion corresponding to the (M+1)-th row in the output image.

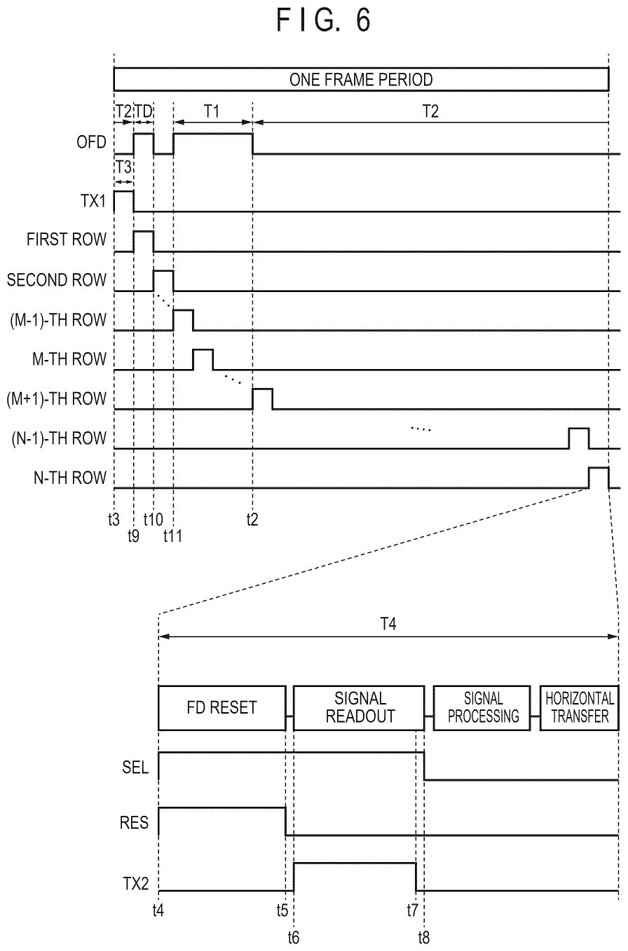

FIG. 6 is a drive timing chart of the photoelectric conversion device according to the embodiment. In the drive timing chart of FIG. 6, the difference from FIG. 4 is that a period TD, which is a reset period of the OB pixel region R2, is added. In the description of FIG. 6, description of portions common to FIG. 4 is omitted as appropriate.

In FIG. 6, it is assumed that the pulse of the period TD between time t9 and time t10 is input to the pixels 11 in the first row to the M-th row in the OB pixel region R2, and is not input to the pixels 11 of the other rows. The pulse in the period T1 from time t11 to the time t2 is input to all the pixels 11 in common as in the case of FIG. 4.

At the time t9, the control signal OFD supplied to the pixels 11 in the first row to the M-th row changes from the low level to the high level. Accordingly, in the pixels 11 in the first row to the M-th row, the discharge transistor M6 is turned on, the charge of the photoelectric conversion unit PD is discharged, and the photoelectric conversion unit PD is reset to a potential corresponding to the power supply potential VDD. That is, the time t9 is the start time of the reset operation for the pixels 11 in the first row to the M-th row.

At the time t10, the control signal OFD supplied to the pixels 11 in the first row to the M-th row changes from the high level to the low level. As a result, in the pixels 11 in the first row to the M-th row, the discharge transistor M6 is turned off. That is, the time t10 is the end time of the reset operation for the pixels 11 in the first row to the M-th row. As described above, the period TD from the time t9 to the time t10 is a period in which the reset operation of the photoelectric conversion units PD of the pixels 11 in the first row to the M-th row included in the OB pixel region R2 is performed.

Thereafter, at the time t11, the control signal OFD supplied to the pixels 11 in all rows changes from the low level to the high level. As a result, in the pixels 11 in all rows, the discharge transistor M6 is turned on, the charge of the photoelectric conversion unit PD is discharged, and the photoelectric conversion unit PD is reset to a potential corresponding to the power supply potential VDD. That is, the time t11 is the start time of the reset operation for the pixels 11 of all the rows.

At the time t2, the control signal OFD supplied to the pixels 11 in all rows changes from the high level to the low level. As a result, the discharge transistors M6 are turned off in the pixels 11 in all rows. That is, the time t2 is the end time of the reset operation for the pixels 11 of all the rows. As described above, the period T1 from the time t11 to the time t2 is a period in which the reset operation of the photoelectric conversion units PD of the pixels 11 in all rows is performed, similarly to the period T1 in FIG. 4. The subsequent operations are the same as those in FIG. 4.

Since the start timing of the charge accumulation is the time t2, the reset operation in the period TD is a dummy reset operation that does not contribute to the length of the period T2 for the charge accumulation. However, in the example of FIG. 6, the start of the reset operation at the time t9 overlaps the readout of the first row, and the end of the reset operation at the time t10 overlaps the readout of the second row. Therefore, noise generated by the start of the reset operation is superimposed on the signal read from the OB pixel in the first row, and noise generated by the end of the reset operation is superimposed on the signal read from the OB pixel in the second row. Since the noise generated by the end of the reset operation is superimposed on the signal read from the effective pixel of the (M+1)-th row, the same noise is superimposed on the signal of the second row and the signal of the (M+1)-th row.

The photoelectric conversion device according to the embodiment reads out a signal on which noise generated by the end of the reset operation in the period TD is superimposed from the OB pixel in the second row and outputs the signal. Since this signal includes a noise component generated by the end of the reset operation, it can be used for the correction processing of the output signal of the effective pixel of the (M+1)-th row on which the noise generated by the end of the reset operation in the period T1 is superimposed. This correction processing can reduce the influence of noise included in the output signal of the effective pixel of the (M+1)-th row.

As described above, in the embodiment, the reset operation is performed on the pixels 11 in the first row to the M-th row of the OB pixel region R2 in the period TD, and the signal on which the noise generated by the reset operation is superimposed is read out from the OB pixel region R2 and output. Then, the reset operation is performed on the pixels 11 of all the rows in the period T1, and the signal on which the noise generated by the reset operation is superimposed is read out from the effective pixel region R1 and output. Therefore, in one frame period, a total of two reset operations are performed in the periods TD and T1 for the pixels 11 in the first row to the M-th row of the OB pixel region R2, and one reset operation is performed in the period T1 for the pixels 11 in the (M+1)-th row to the N-th row of the effective pixel region R1. That is, in one frame period from the start of one scan to the start of the next scan, the reset operation is performed more times for the pixels 11 in the first row to the M-th row of the OB pixel region R2 than for the pixels 11 in the (M+1)-th row to the N-th row of the effective pixel region R1. This is because a dummy reset operation is added to the pixels 11 in the first row to the M-th row of the OB pixel region R2 in order to generate signals for correction.

By applying the driving method as illustrated in FIG. 6, it is possible to output the correction signal for noise generated by the reset operation for the global electronic shutter operation. Therefore, according to the embodiment, a photoelectric conversion device capable of reducing the influence of noise generated by the global electronic shutter operation is provided.

The above-described correction processing may be performed in the signal processing circuit 28, for example. Specifically, for example, a line memory (not illustrated) provided in the photoelectric conversion device holds the digital signal of the second row read in the period TD. Then, the signal processing circuit 28 corrects the digital signal of the (M+1)-th row by performing arithmetic processing on the digital signal of the (M+1)-th row based on the digital signal of the second row. The line memory may have a storage capacity for storing signals corresponding to the number of columns of the pixel array 10, for example.

Alternatively, the correction processing may be performed, for example, in a signal processing device external to the photoelectric conversion device. Specifically, for example, a memory arranged in a signal processing device external to the photoelectric conversion device holds the digital signal of the second row read in the period TD. Then, the signal processing device corrects the digital signal of the (M+1)-th row by performing arithmetic processing on the digital signal of the (M+1)-th row based on the digital signal of the second row.

In addition, in the driving method of FIG. 6, since the readout period for at least one row is set the period TD, the upper limit of the length of the charge accumulation period T2 may be small. However, when the readout period of the effective pixel region R1 and the end time of the reset operation in the period T1 do not overlap, that is, when the end time of the reset operation in the period T1 is set within the readout period of the OB pixel region R2, the period TD is not necessary. Therefore, the method of the embodiment does not substantially affect the upper limit of the length of the charge accumulation period T2. That is, the timing, the length, and the like of the period TD can be appropriately set according to the setting of the period T2.

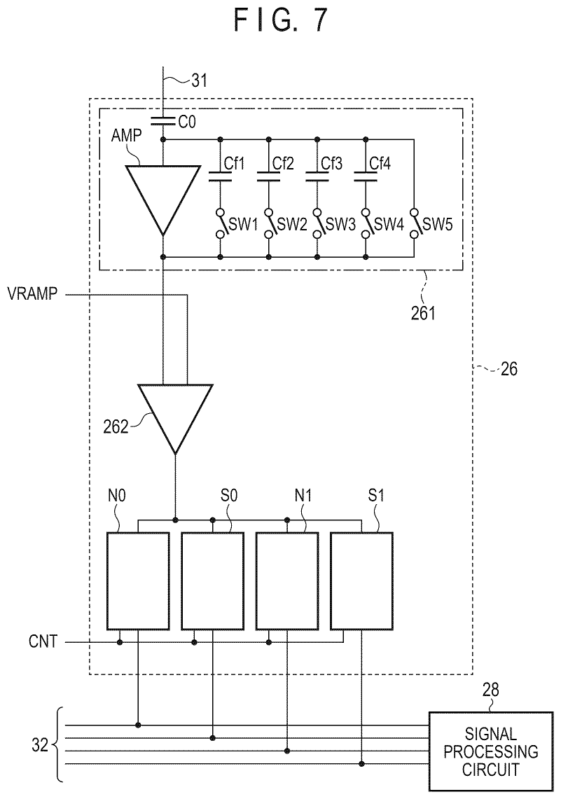

FIG. 7 is a diagram illustrating a modification of the equivalent circuit of the column circuit 26 according to the embodiment. This modification is an example in which the column circuit 26 includes memories that hold the digital signals of the second row read in the period TD. The column circuit 26 further includes memories N1 and S1 in addition to the configuration of FIG. 3. First input terminals of the memories N1 and S1 are connected to the output terminal of the comparator 262. The count signal CNT is input from the counter circuit 24 to second input terminals of the memories N1 and S1. Output terminals of the memories N1 and S1 are connected to the signal processing circuit 28 via a horizontal output line 32. In the modification, the horizontal output line 32 includes four wirings.

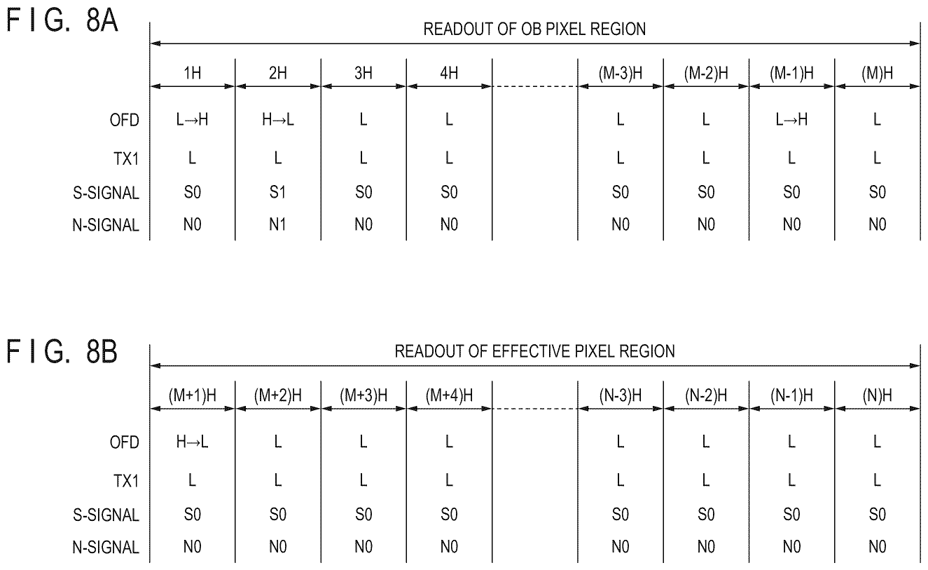

FIGS. 8A and 8B are diagrams illustrating driving of the pixels and holding of data in the memories according to the embodiment. FIG. 8A illustrates the levels of the control signals OFD and TX1 and the memories in which the S-signal and the N-signal are held in the readout period of the OB pixel region R2. FIG. 8B illustrates the levels of the control signals OFD and TX1 and the memories in which the S-signal and the N-signal are held in the readout period of the effective pixel region R1. In FIGS. 8A and 8B, it is assumed that the column circuit 26 has the configuration illustrated in FIG. 7.

In FIG. 8A, “1H” to “(M)H” indicate a period of reading of the first row to a period of reading of the M-th row, respectively. In FIG. 8B, “(M+1)H” to “(N)H” indicate a period of reading of the (M+1)-th row to a period of reading of the N-th row, respectively. In FIGS. 8A and 8B, “L” indicates that the control signal is at the low level. In FIGS. 8A and 8B, “L→H” indicates that the control signal transitions from the low level to the high level, and “H→L” indicates that the control signal transitions from the high level to the low level.

FIGS. 8A and 8B correspond to the drive timing chart of FIG. 6. As illustrated in FIG. 8A, at the read timing (1H) of the first row, the control signal OFD transitions from the low level to the high level, and the reset operation starts. At this time, the S-signal is held in the memory S0, and the N-signal is held in the memory N0. In addition, at the read timing (2H) of the second row, the control signal OFD transitions from the high level to the low level, and the reset operation ends. At this time, the S-signal is held in the memory S1, and the N-signal is held in the memory N1. Further, at the read timing ((M−1)H) of the (M−1)-th row, the control signal OFD transitions from the low level to the high level, and the reset operation starts. At this time, the S-signal is held in the memory S0, and the N-signal is held in the memory N0. As described above, the signals acquired from the OB pixel region R2 at the timing of the end of the reset operation are held in the memories N1 and S1 different from memories holding the signals acquired at the other timings, and are maintained without being overwritten until the time of the subsequent reading of the effective pixel region R1.

As illustrated in FIG. 8B, at the read timing ((M+1)H) of the (M+1)-th row, the control signal OFD transitions from the high level to the low level, and the reset operation ends. At this time, the S-signal is held in the memory S0, and the N-signal is held in the memory N0. Then, the digital signals of the (M+1)-th row held in the memories N0 and S0 and the digital signals of the second row held in the memories N1 and S1 are input to the signal processing circuit 28. The signal processing circuit 28 performs correction processing using these digital signals to reduce the influence of noise generated by the end of the reset operation.

Here, an example of correction processing performed in the signal processing circuit 28 will be described. The digital signals held in the memories N0 and S0 are denoted by DN0 and DS0, respectively, and the digital signals held in the memories N1 and S1 are denoted by DN1 and DS1, respectively. The digital signals of the rows (other than the (M+1)-th row) in which the start or end of the reset operation is not performed in an overlapping manner with the readout of the effective pixel region R1 are subjected to the correction processing by Expression (1). In addition, the digital signals of the row (the (M+1)-th row) in which the start or the end of the reset operation is performed in an overlapping manner with the readout of the effective pixel region R1 are corrected by Expression (2). However, the equation used in the correction processing is not limited to the Expressions (1) and (2).

$$DS 0 - DN 0 \qquad ( 1 )$$

$$DS 0 - DN 0 - ( DS 1 - DN 1 ) \qquad ( 2 )$$

The transfer of the digital signals from the memories N1 and S1 to the signal processing circuit 28 may be performed at the time of readout of each row, or may be performed only at the time of readout of a row overlapping with the start or end of the reset operation at the time of readout of the effective pixel region R1.

The storage capacities of the memories N0 and S0 may be different from the storage capacities of the memories N1 and S1. The column circuit 26 may have a configuration in which only one of the memories N1 and S1 is arranged.

The digital signals may not be held in the memories N1 and S1 every frame. For example, the digital signals may be held in the memories N1 and S1 at a rate of once per a plurality of frames, and in this case, the signal processing circuit 28 may share the digital signals of the memories N1 and S1 during processing of a plurality of frames.

A state in which the digital signals are held in the memories N1 and S1 and a state in which the digital signals are not held in the memories N1 and S1 may be switchable. This switching may be performed based on settings of an imaging device in which the photoelectric conversion device is mounted, such as an imaging target and a gain setting of a camera. For example, the influence of noise generated by the reset operation is likely to appear as stripes in the horizontal direction in a situation where the noise level is low due to factors other than the reset operation, such as when photographing in a dark place or when photographing an imaging target with low luminance. Therefore, for example, when the imaging target has a luminance higher than a predetermined value, the digital signals may not be held in the memories N1 and S1. Further, for example, when the gain setting of the camera is higher than a predetermined value, the digital signals may not be held in the memories N1 and S1. Further, whether or not the digital signals are held in the memories N1 and S1 may be set based on other settings.

One pixel 11 may include a plurality of sub-pixels. The output signals from each of the plurality of sub-pixels may be used for phase difference focus detection. In this case, the memories N1 and S1 may be arranged so as to hold output signals of each of the plurality of sub-pixels, or the memories N1 and S1 may be arranged so as to hold output signals of any of the plurality of sub-pixels. Alternatively, the memories N1 and S1 may be arranged so as to hold the addition result of the signal outputs of the plurality of sub-pixels.

In the embodiment, the signals from the plurality of pixels 11 are read out one row at a time, but the number of rows simultaneously read out is not limited to one. For example, a plurality of vertical output lines 31 are arranged for one column of pixels 11. Then, in a period in which a signal is output from a pixel 11 in one row to one of the plurality of vertical output lines 31, a signal is output from a pixel 11 in another row to another one of the plurality of vertical output lines 31, so that signals can be simultaneously output from the pixels 11 in the plurality of rows.

In addition, although the photoelectric conversion device of the embodiment includes the pixel array 10 and circuits that process signals output from the pixel array 10, such as the current source 25 and the column circuit 26, these circuits may be arranged in one substrate or may be arranged in a plurality of substrates. For example, a first substrate in which the pixel array 10 is arranged and one or a plurality of second substrates in which circuits related to signal processing including the current source 25, the column circuit 26, and the like are arranged may be stacked. In this case, as illustrated in FIG. 1, the current source 25, the column circuit 26, and the like may be arranged for each column of the plurality of pixels 11, or may be arranged corresponding to a plurality of pixels 11 arranged in a part of the pixel array 10.

Although FIG. 2 illustrates a configuration in which the pixel 11 includes the selection transistor M5, the configuration is not limited to this example. As another example, the pixel 11 may not include the selection transistor M5. In this case, the vertical output line 31 is connected to the source of the amplification transistor M4. The selection of the row from which the signal is output can be realized by changing the potential supplied to the drain of the reset transistor M3. That is, the drain of the reset transistor M3 in the row that does not output a signal is supplied with a potential (off-potential) at which the amplification transistor M4 is turned off. When the reset transistor M3 is turned on under the control of the vertical scanning circuit 22, the off-potential is applied to the floating diffusion FD. As a result, the amplification transistor M4 whose gate is supplied with the off-potential is turned off. On the other hand, the drain of the reset transistor M3 in the row that outputs the signal is supplied with a potential (on-potential) at which the amplification transistor M4 is turned on. When the reset transistor M3 is turned on under the control of the vertical scanning circuit 22, the on-potential is applied to the floating diffusion FD. As a result, the amplification transistor M4 whose gate is supplied with the on-potential is turned on, and a signal can be output to the vertical output line 31.

In the embodiment, an example in which the photoelectric conversion unit PD is reset by the power supply potential VDD is illustrated, but the embodiment is not limited thereto. The photoelectric conversion unit PD may be reset by another potential.

In addition, the holding unit CM1 and the floating diffusion FD may have a capacitance to hold the transferred charge. That is, the structures of the capacitance elements constituting the holding unit CM1 and the floating diffusion FD are not particularly limited. The holding unit CM1 and the floating diffusion FD may include, for example, a structure using a junction capacitance of a P-type semiconductor region and an N-type semiconductor region, and may include an MIM structure in which a dielectric is sandwiched by metals.

### Second Embodiment

In the embodiment, a modification in which a holding unit and a transfer transistor are added to the pixel of the first embodiment will be described. In the embodiment, description of elements common to those of the first embodiment may be omitted or simplified.

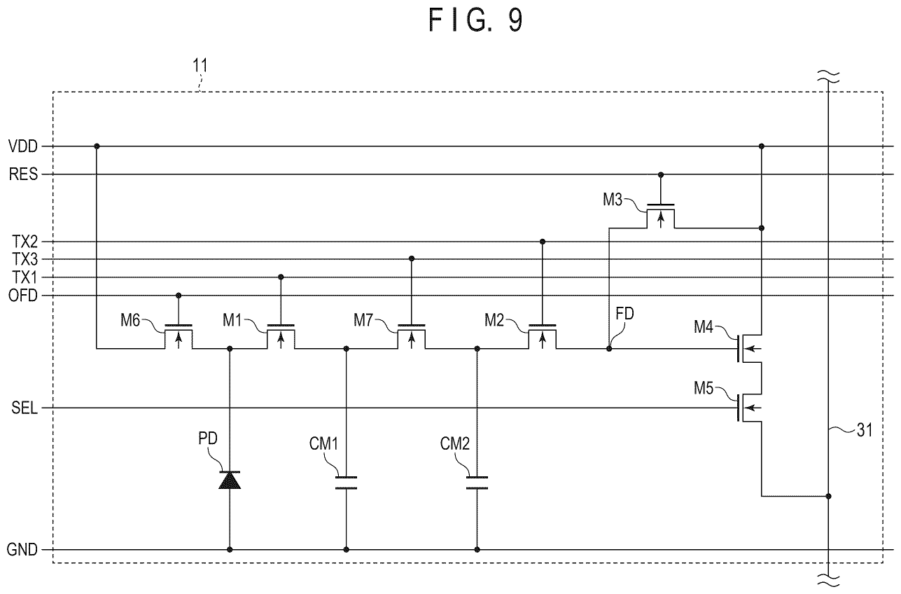

FIG. 9 is a diagram illustrating an equivalent circuit of the pixel 11 according to the embodiment. The pixel 11 of the embodiment further includes a third transfer transistor M7 and a holding unit CM2 in addition to the configuration of the pixel 11 of the first embodiment illustrated in FIG. 2. A source of the third transfer transistor M7 is connected to a connection node between the drain of the first transfer transistor and the holding unit CM1. A drain of the third transfer transistor M7 is connected to the source of the second transfer transistor M2 and the holding unit CM2. A control signal TX3 is supplied to a gate of the third transfer transistor M7. When the third transfer transistor M7 is controlled to be turned on by the control signal TX3, the charge held in the holding unit CM1 is transferred to the holding unit CM2. The holding unit CM2 has a capacitance that holds the charge transferred from the holding unit CM1. When the second transfer transistor M2 is controlled to be turned on by the control signal TX2, the charge held in the holding unit CM2 is transferred to the floating diffusion FD.

The configuration of other portions in the pixel 11 is the same as that in FIG. 2, and thus description thereof is omitted. The overall configuration of the photoelectric conversion device, the configuration of the column circuit 26, the arrangement of the pixel regions, and the like are the same as those of the first embodiment, and the description thereof will be omitted.

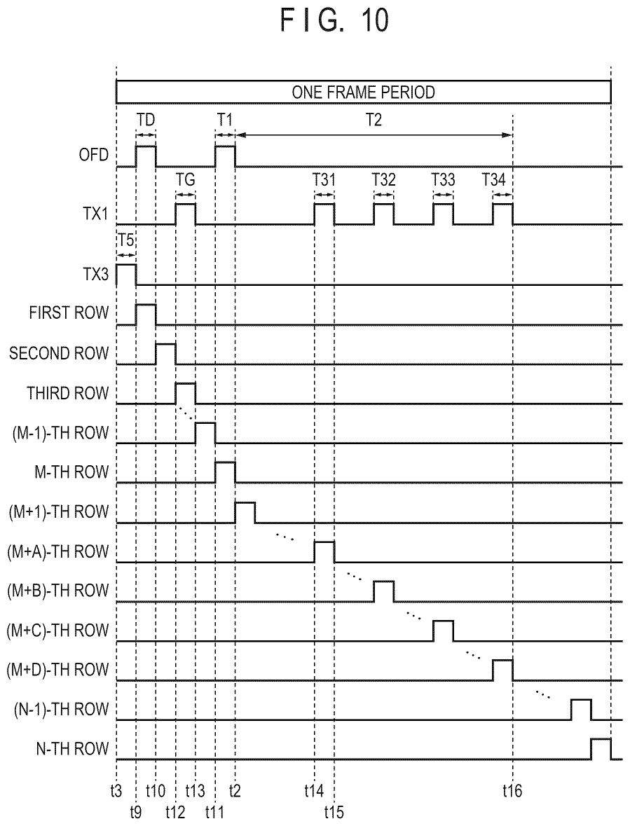

FIG. 10 is a drive timing chart of the photoelectric conversion device according to the embodiment. FIG. 10 illustrates timings of potential changes of the control signals OFD, TX1, and TX3 and a timing of the readout of each row in one frame period. The timings of the control signals SEL, RES, and TX2 at the time of reading each row are the same as those in the period T4 of FIG. 4 or FIG. 6, and thus illustration thereof is omitted in FIG. 10.

At the time t11, the control signal OFD changes from the low level to the high level. As a result, the discharge transistor M6 is turned on, the charge of the photoelectric conversion unit PD is discharged, and the photoelectric conversion unit PD is reset to a potential corresponding to the power supply potential VDD. That is, the time t11 is the start time of the reset operation. At the time t2, the control signal OFD changes from the high level to the low level. As a result, the discharge transistor M6 is turned off. That is, the time t2 is the end time of the reset operation. As described above, the period T1 from the time t11 to the time t2 is a period in which the reset operation of the photoelectric conversion unit PD is performed.

In the period T2 after the time t2, the charge is accumulated in the photoelectric conversion unit PD by the incident light. That is, the time t2 is the start time of the charge accumulation operation, and the period T2 is the charge accumulation operation period in the photoelectric conversion unit PD.

Thereafter, at time t14, the control signal TX1 changes from the low level to the high level. Accordingly, the first transfer transistor M1 is turned on, and the charge accumulated in the photoelectric conversion unit PD in the period from the time t2 to the time t14 is transferred to the holding unit CM1. That is, the time t14 is the start time of the transfer operation. At time t15, the control signal TX1 changes from the high level to the low level. As a result, the first transfer transistor M1 is turned off. That is, the time t15 is the end time of the transfer operation. As described above, a period T31 from the time t14 to the time t15 is a period in which the transfer operation from the photoelectric conversion unit PD to the holding unit CM1 is performed.

Thereafter, in periods T32, T33, and T34, similarly to the period T31, the charge accumulated in the photoelectric conversion unit PD is transferred to the holding unit CM1 by the first transfer transistor M1. As described above, in the embodiment, the charge transfer from the photoelectric conversion unit PD to the holding unit CM1 is performed a plurality of times. Time t16 at which the fourth charge transfer ends is the end time of the period T2. The charge generated in the photoelectric conversion unit PD in a period after the period T2 is discharged through the discharge transistor M6, and thus does not contribute to the output signal of the photoelectric conversion device.

The driving method in which charge transfer is performed a plurality of times as illustrated in FIG. 10 is effective in reducing the influence of saturation in a case where there is a difference between the maximum charge amount (first saturation charge amount) that can be accumulated in the photoelectric conversion unit PD and the maximum charge amount (second saturation charge amount) that can be accumulated in the holding unit CM1, for example. A case where the second saturation charge amount is larger than the first saturation charge amount will be described, for example. When the charge amount of the photoelectric conversion unit PD reaches the first saturation charge amount in a period until the start of transfer at a predetermined time within the period T2, the photoelectric conversion unit PD cannot accumulate charge thereafter. Therefore, by transferring the charge accumulated in the photoelectric conversion unit PD to the holding unit CM1 in the period T31 in the middle of the period T2, the photoelectric conversion unit PD returns to the initial state in which the charge is discharged. Therefore, even when the first saturation charge amount of the photoelectric conversion unit PD is small, if the second saturation charge amount of the holding unit CM1 is sufficiently large, it is possible to sufficiently secure the saturation charge amount of the pixel 11 that can be detected in one frame period. By designing the photoelectric conversion unit PD and the holding unit CM1 in consideration of the charge amount that can be accumulated per unit area of the photoelectric conversion unit PD and the holding unit CM1 and the pixel pitch, it is possible to make the saturation charge amount of the pixel 11 and the areas of the photoelectric conversion unit PD and the holding unit CM1 more suitable.

After the period T34, at the time t3 of the next frame period, the control signal TX3 changes from the low level to the high level. Accordingly, the third transfer transistor M7 is turned on, and the charge generated in the photoelectric conversion unit PD and transferred to the holding unit CM1 in the period T2 of the previous frame period is transferred to the holding unit CM2. That is, the time t3 is the start time of the transfer operation. At the time t9, the control signal TX3 changes from the high level to the low level. As a result, the third transfer transistor M7 is turned off. That is, the time t9 is the end time of the transfer operation. A period T5 from the time t3 to the time t9 is a period in which the transfer operation from the holding unit CM1 to the holding unit CM2 is performed.

Although the period T5 is set at the beginning of one frame period in FIG. 10, the embodiment is not limited thereto. The period T5 may be set from before reading of each row is completed to before reading starts next. For example, the period T5 may be set at the end of one frame period.

The control signals OFD, TX1, and TX3 collectively control the plurality of pixels 11. Therefore, the start time of the charge accumulation period in the photoelectric conversion unit PD is the same in the plurality of pixels 11. The end time of the charge accumulation period in the photoelectric conversion unit PD is also the same in the plurality of pixels 11. That is, the photoelectric conversion device of the embodiment can perform the global electronic shutter operation in which the charge accumulation periods of the plurality of pixels 11 coincide with each other.

As in the example of FIG. 6 of the first embodiment, it is assumed that the range from the first row to the M-th row is the OB pixel region R2, and the range from the (M+1)-th row to the N-th row is the effective pixel region R1. As in the example of FIG. 6 of the first embodiment, also in the embodiment, the dummy reset operation is performed on the pixels 11 in the OB pixel region R2 in the period TD between the time t9 and the time t10.

At the time t9, the control signal OFD supplied to the pixels 11 in the first row to the M-th row changes from the low level to the high level. Accordingly, in the pixels 11 in the first row to the M-th row, the discharge transistor M6 is turned on, the charge of the photoelectric conversion unit PD is discharged, and the photoelectric conversion unit PD is reset to a potential corresponding to the power supply potential VDD. That is, the time t9 is the start time of the reset operation for the pixels 11 in the first row to the M-th row.

At the time t10, the control signal OFD supplied to the pixels 11 in the first row to the M-th row changes from the high level to the low level. Accordingly, in the pixels 11 in the first row to the M-th row, the discharge transistor M6 is turned off. That is, the time t10 is the end time of the reset operation for the pixels 11 in the first row to the M-th row. As described above, the period TD from the time t9 to the time t10 is a period in which the reset operation of the photoelectric conversion units PD of the pixels 11 in the first row to the M-th row included in the OB pixel region R2 is performed.

Thus, similarly to the photoelectric conversion device of the first embodiment, the photoelectric conversion device of the embodiment can read out a signal on which noise generated by the end of the reset operation in the period TD is superimposed from the OB pixel of the second row and output the signal. By the correction processing using this signal, similarly to the first embodiment, it is possible to reduce the influence of noise, which is included in the output signal of the effective pixel of the (M+1)-th row and is generated by the end of the reset operation.

In the driving method in FIG. 10, there is a case where the start or the end of the transfer operation in the period T31 to the period T34 overlaps with the period of reading signals from the pixels 11 in a certain row. In FIG. 10, for example, the start of the transfer operation at the time t14 overlaps with the reading of the (M+A)-th row. Accordingly, noise generated by the start of the transfer operation may be superimposed on the output signal at the time of reading of the (M+A)-th row due to a factor similar to the case of the start or end of the reset operation. Since the output signal of the (M+A)-th row may be affected by noise caused by the start of the transfer operation, a horizontal stripe may occur in a portion corresponding to the (M+A)-th row in the output image. Similarly, noise generated by the start of the transfer operation in the periods T32, T33, and T34 may affect the output signals of the (M+B)-th row, the (M+C)-th row, and the (M+D)-th row. In addition, the end of the transfer operation may also cause noise. For example, at the time of reading one row (for example, the (M+A+1)-th row) between the (M+A)-th row and the (M+B)-th row, noise generated by the end of the transfer operation at the time t15 may be superimposed on the output signal.

As described above, in the embodiment, the transfer operation in addition to the reset operation may cause noise. The noise caused by the transfer operation can also be corrected by the same method as the correction of the noise caused by the reset operation. Therefore, in the embodiment, a dummy transfer operation is performed on the pixels 11 in the OB pixel region R2 in a period TG from time t12 to time t13.

At the time t12, the control signal TX1 supplied to the pixels 11 in the first row to the M-th row changes from the low level to the high level. Accordingly, in the pixels 11 in the first row to the M-th row, the first transfer transistor M1 is turned on, and the charge of the photoelectric conversion unit PD is transferred to the holding unit CM1. That is, the time t12 is the start time of the transfer operation for the pixels 11 in the first row to the M-th row.

At the time t13, the control signal TX1 supplied to the pixels 11 in the first row to the M-th row changes from the high level to the low level. As a result, the first transfer transistor M1 is turned off in the pixels 11 in the first row to the M-th row. That is, the time t13 is the end time of the transfer operation for the pixels 11 in the first row to the M-th row. As described above, the period TG from the time t12 to the time t13 is a period in which the transfer operation of the photoelectric conversion units PD of the pixels 11 in the first row to the M-th row included in the OB pixel region R2 is performed.

Since the start timing of the charge accumulation is the time t2 and the end timing of the charge accumulation is the time t16, the transfer operation in the period TG is a dummy transfer operation that does not contribute to the length of the period T2 for the charge accumulation. However, in the example of FIG. 10, the start of the transfer operation at the time t12 overlaps the readout of the third row. Therefore, noise generated by the start of the transfer operation is superimposed on the signal read from the OB pixel of the third row. Noise generated by the start of the reset operation is also superimposed on signals read from the effective pixels of the (M+A)-th row, the (M+B)-th row, the (M+C)-th row, and the (M+D)-th row. Therefore, the same noise is superimposed on the signal of the third row and the signals of the (M+A)-th row, the (M+B)-th row, the (M+C)-th row, and the (M+D)-th row.

In the photoelectric conversion device according to the embodiment, the signal on which the noise generated by the start of the transfer operation in the period TG is superimposed is read from the OB pixel in the third row and output. This signal includes a noise component generated by the start of the transfer operation. Therefore, this signal can be used for correction processing of the output signals of the effective pixels of the (M+A)-th row, the (M+B)-th row, the (M+C)-th row, and the (M+D)-th row on which the noise generated by the start of the transfer operation in the periods T31, T32, T33, and T34 is superimposed. This correction processing can reduce the influence of noise included in the output signals of the effective pixels of the (M+A)-th row, the (M+B)-th row, the (M+C)-th row, and the (M+D)-th row.

As described above, the photoelectric conversion device according to the embodiment performs the transfer operation on the pixels 11 in the first row to the M-th row of the OB pixel region R2 in the period TG, and reads out the signal on which the noise generated by the transfer operation is superimposed from the OB pixel region R2 and outputs the signal. Then, in the periods T31, T32, T33, and T34, the transfer operation is performed on the pixels 11 of all the rows, and the signal on which the noise generated by the transfer operation is superimposed is read out from the effective pixel region R1 and output the signal.

This makes it possible to output a noise correction signal generated by the transfer operation for the global electronic shutter operation. Therefore, according to the embodiment, a photoelectric conversion device capable of reducing the influence of noise generated by the global electronic shutter operation is provided.

The above-described correction processing may be performed in the signal processing circuit 28, for example. Specifically, for example, a line memory (not illustrated) provided in the photoelectric conversion device holds the digital signal of the third row read in the period TG. Then, the signal processing circuit 28 performs arithmetic processing on the digital signals of the (M+A)-th row, the (M+B)-th row, the (M+C)-th row, and the (M+D)-th row based on the digital signal of the third row, thereby correcting the digital signals of these rows. The line memory may have a storage capacity for storing signals corresponding to the number of columns of the pixel array 10, for example.

Alternatively, the correction processing may be performed, for example, in a signal processing device external to the photoelectric conversion device. Specifically, for example, a memory in the signal processing device external to the photoelectric conversion device holds the digital signal of the third row read in the period TG. Then, the signal processing device performs arithmetic processing on the digital signals of the (M+A)-th row, the (M+B)-th row, the (M+C)-th row, and the (M+D)-th row based on the digital signal of the third row, so that the digital signals of these rows are corrected.

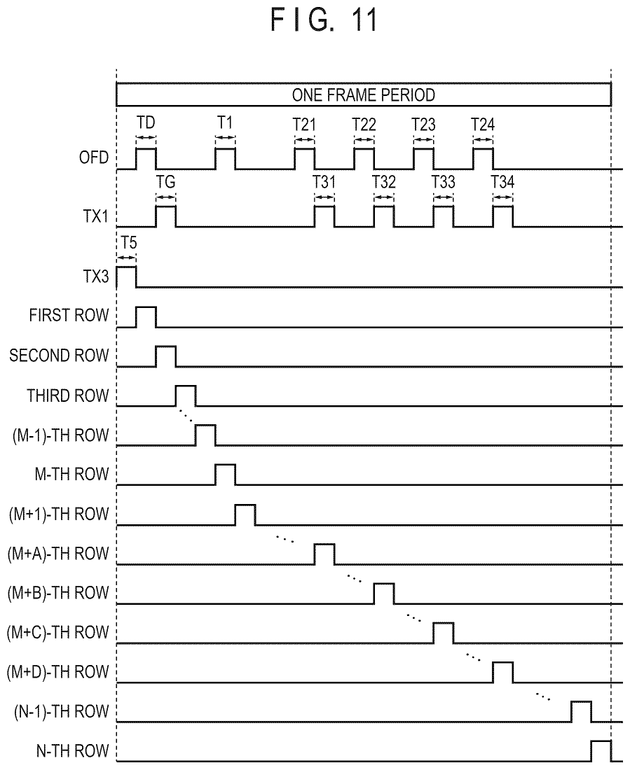

FIG. 11 is a diagram illustrating a modification of drive timings of the photoelectric conversion device according to the embodiment. FIG. 11 is different from FIG. 10 in that periods T21, T22, T23, and T24 in which the reset operation of the photoelectric conversion unit PD is performed are added. The period T21 is set before the period T31, the period T22 is set between the period T31 and the period T32, the period T23 is set between the period T32 and the period T33, and the period T24 is set between the period T33 and the period T34. That is, in the modification, driving in which the reset operation of the photoelectric conversion unit PD and the transfer operation from the photoelectric conversion unit PD to the holding unit CM1 are alternately repeated is performed.

When the imaging target is a blinking body, or when the stroboscopic imaging is performed, the amount of light incident on the photoelectric conversion device may change at a predetermined period or with the passage of time. In the driving methods of FIGS. 4, 6, and 10, the photoelectric conversion unit PD is in the reset state within the period T1, and the charge accumulation operation is not performed. Therefore, when the amount of light changes within the period T1, appropriate signal acquisition may not be performed. On the other hand, as illustrated in FIG. 11, by setting the driving method in which the reset operation and the transfer operation are alternately repeated a plurality of times in a predetermined time range within one frame period, or by equally allocating the reset operation and the transfer operation within one frame period, the influence of the temporal change of the light amount can be reduced. In addition, by appropriately adjusting the number of times of repeating the reset operation and the transfer operation or the interval between the repetitions, the photoelectric conversion device can be controlled so that the photoelectric conversion unit PD and the holding unit CM1 are not saturated even when the object has high luminance.

In the driving method in FIG. 11, there is a case where the start or the end of the reset operation in the period T21 to the period T24 overlaps with the period of reading signals from the pixels 11 in a certain row. In FIG. 11, for example, the end of the reset operation in the period T22 and the start of the transfer operation in the period T32 overlap with the readout of the (M+B)-th row. Accordingly, the output signal of the (M+B)-th row may be affected by noise caused by the end of the reset operation and the start of the transfer operation. In the modification, since the noise caused by the end of the reset operation and the start of the transfer operation is superimposed at the time of reading the second row, the influence of the noise can be reduced by performing the correction processing using the signal read from the OB pixel of the second row.

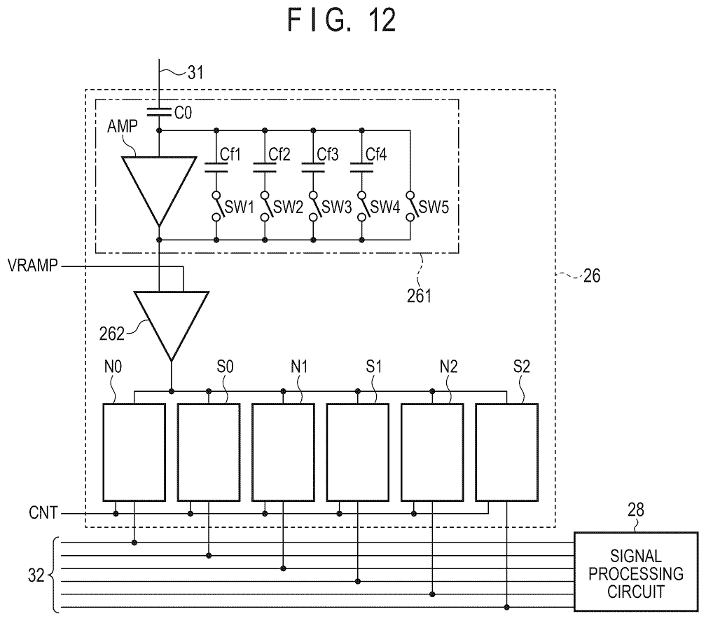

FIG. 12 is a diagram illustrating an equivalent circuit of the column circuit 26 according to the embodiment. The column circuit 26 further includes memories N2 and S2 in addition to the configuration of FIG. 7. First input terminals of the memories N2 and S2 are connected to the output terminal of the comparator 262. The count signal CNT is input from the counter circuit 24 to second input terminals of the memories N2 and S2. Output terminals of the memories N2 and S2 are connected to the signal processing circuit 28 via a horizontal output line 32. In the modification, the horizontal output line 32 includes six wirings.

In the memories N1 and S1, for example, the digital signals read at the timing of the period TD are held. In the memories N2 and S2, for example, the digital signals read at the timing of the period TG are held. The memories N0 and S0 hold, for example, digital signals read at timings other than the periods TD and TG. However, the allocation of signals held in the memories is not limited to the above-described example, and can be appropriately changed in accordance with a driving method or the like to be applied.

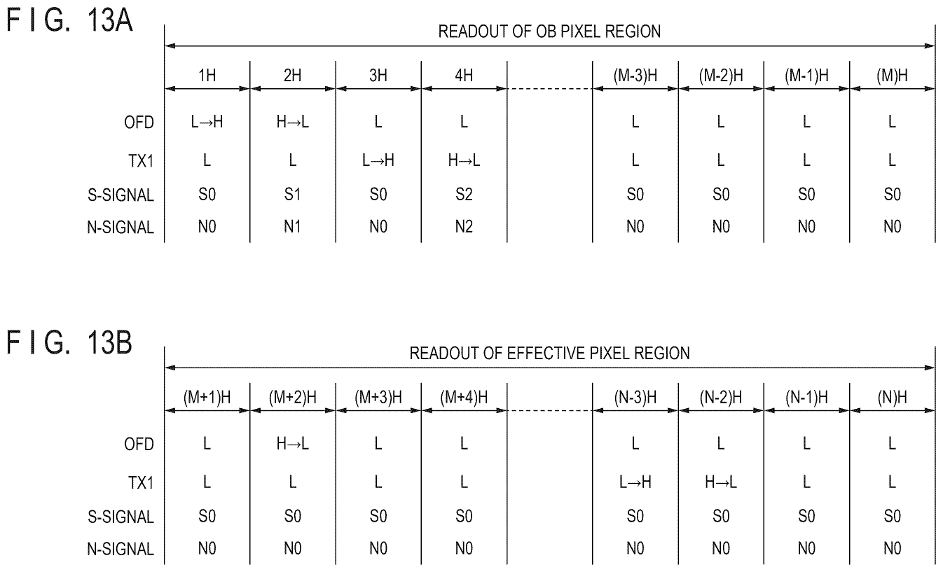

FIGS. 13A and 13B are diagrams illustrating driving of the pixels and holding of data in the memories according to the embodiment. The notation methods in FIGS. 13A and 13B are similar to those in FIGS. 8A and 8B. In FIGS. 13A and 13B, it is assumed that the column circuit 26 has the configuration illustrated in FIG. 12. The example illustrated in FIGS. 13A and 13B does not correspond to the driving methods of FIGS. 10 and 11.

As illustrated in FIG. 13A, at the read timing (1H) of the first row, the control signal OFD transitions from the low level to the high level, and the reset operation starts. At this time, the S-signal is held in the memory S0, and the N-signal is held in the memory N0. In addition, at the read timing (2H) of the second row, the control signal OFD transitions from the high level to the low level, and the reset operation ends. At this time, the S-signal is held in the memory S1, and the N-signal is held in the memory N1. At the read timing (3H) of the third row, the control signal TX1 transitions from the low level to the high level, and the transfer operation starts. At this time, the S-signal is held in the memory S0, and the N-signal is held in the memory N0. Further, at the read timing (4H) of the fourth row, the control signal TX1 transitions from the high level to the low level, and the transfer operation ends. At this time, the S-signal is held in the memory S2, and the N-signal is held in the memory N2. As described above, the signals acquired from the OB pixel region R2 at the timing of the end of the reset operation are held in the memories N1 and S1, and the signals acquired from the OB pixel region R2 at the timing of the end of the transfer operation are held in the memories N2 and S2. The signals held in the memories N1, S1, N2, and S2 are maintained without being overwritten until the time of the subsequent reading of the effective pixel region R1.

As illustrated in FIG. 13B, at the read timing ((M+2)H) of the (M+2)-th row, the control signal OFD transitions from the high level to the low level, and the reset operation ends. At this time, the S-signal is held in the memory S0, and the N-signal is held in the memory N0. At this time, the digital signals of the (M+2)-th row held in the memories N0 and S0 and the digital signals of the second row held in the memories N1 and S1 are input to the signal processing circuit 28. The signal processing circuit 28 performs correction processing using these digital signals to reduce the influence of noise generated by the end of the reset operation.

As illustrated in FIG. 13B, at the read timing ((N−2)H) of the (N−2)-th row, the control signal TX1 transitions from the high level to the low level, and the transfer operation ends. At this time, the S-signal is held in the memory S0, and the N-signal is held in the memory N0. Then, the digital signals of the (N−2)-th row held in the memories N0 and S0 and the digital signals of the fourth row held in the memories N2 and S2 are input to the signal processing circuit 28. The signal processing circuit 28 performs correction processing using these digital signals to reduce the influence of noise generated by the end of the transfer operation.

Although FIGS. 13A and 13B illustrate an example in which the influence of noise at the end of the reset operation and the transfer operation is reduced, the driving method may be modified so as to reduce the influence of noise at the start of the reset operation and the transfer operation. In addition, it may be possible to select, for each frame, which of noise at the start and noise at the end of the reset operation and the transfer operation is to be reduced.

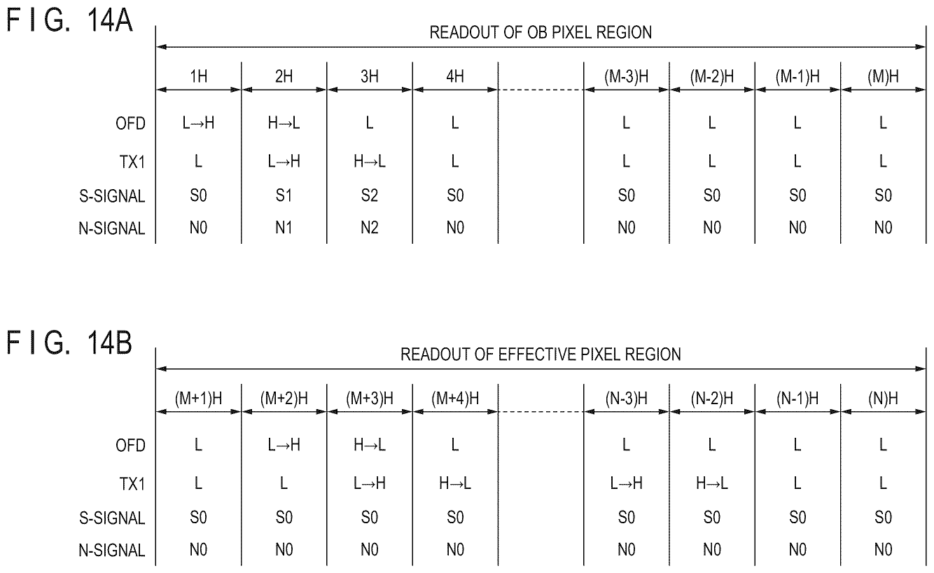

FIGS. 14A and 14B are diagrams illustrating a modification of driving the pixels and holding data in the memories according to the embodiment. Since FIGS. 14A and 14B are modifications of FIGS. 13A and 13B, differences from FIGS. 13A and 13B will be mainly described below. The example illustrated in FIGS. 14A and 14B does not correspond to the driving methods illustrated in FIGS. 10 and 11.

As illustrated in FIG. 14A, at the read timing (2H) of the second row, the control signal OFD transitions from the high level to the low level, and the reset operation ends. At the read timing (2H) of the second row, the control signal TX1 transitions from the low level to the high level, and the transfer operation starts. At this time, the S-signal is held in the memory S1, and the N-signal is held in the memory N1. At the read timing (3H) of the third row, the control signal TX1 transitions from the high level to the low level, and the transfer operation ends. At this time, the S-signal is held in the memory S2, and the N-signal is held in the memory N2. As described above, the signals acquired from the OB pixel region R2 at the timing of the end of the reset operation and the start of the transfer operation are held in the memories S1 and N1, and the signals acquired from the OB pixel region R2 at the timing of the end of the transfer operation are held in the memories N2 and S2.

As illustrated in FIG. 14B, at the read timing ((M+3)H) of the (M+3)-th row, the control signal OFD transitions from the high level to the low level, and the reset operation ends. At the read timing ((M+3)H) of the (M+3)-th row, the control signal TX1 transitions from the low level to the high level, and the transfer operation starts. At this time, the S-signal is held in the memory S0, and the N-signal is held in the memory N0. Then, the digital signals of the (M+3)-th row held in the memories N0 and S0 and the digital signals of the second row held in the memories N1 and S1 are input to the signal processing circuit 28. The signal processing circuit 28 performs correction processing using these digital signals to reduce the influence of noise generated by the end of the reset operation and the start of the transfer operation. As described above, noise may occur due to both the reset operation and the transfer operation, and such noise can be corrected in the modification.

As illustrated in FIG. 14B, at the read timing ((N−2)H) of the (N−2)-th row, the control signal TX1 transitions from the high level to the low level, and the transfer operation ends. At this time, the S-signal is held in the memory S0, and the N-signal is held in the memory N0. Then, the digital signals of the (N−2)-th row held in the memories N0 and S0 and the digital signals of the third row held in the memories N2 and S2 are input to the signal processing circuit 28. The signal processing circuit 28 performs correction processing using these digital signals to reduce the influence of noise generated by the end of the transfer operation.

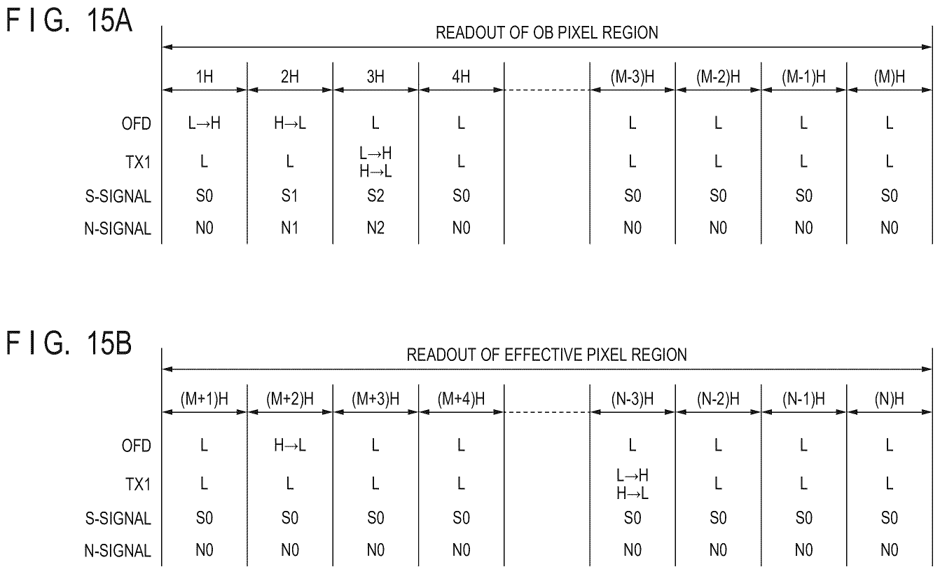

FIGS. 15A and 15B are diagrams illustrating a modification of driving the pixels and holding data in the memories according to the embodiment. Since FIGS. 15A and 15B are modifications of FIGS. 13A and 13B or FIGS. 14A and 14B, differences from FIGS. 13A and 13B or FIGS. 14A and 14B will be mainly described below. The example illustrated in FIGS. 15A and 15B does not correspond to the driving methods illustrated in FIGS. 10 and 11.

As illustrated in FIG. 15A, at the read timing (2H) of the second row, the control signal OFD transitions from the high level to the low level, and the reset operation ends. At this time, the S-signal is held in the memory S1, and the N-signal is held in the memory N1. At the read timing (3H) of the third row, the control signal TX1 transitions from the low level to the high level, and further transitions from the high level to the low level to start and end the transfer operation. At this time, the S-signal is held in the memory S2, and the N-signal is held in the memory N2. As described above, the signals acquired from the OB pixel region R2 at the timing of the end of the reset operation is held in the memories N1 and S1, and the signals acquired from the OB pixel region R2 at the timing of the start and end of the transfer operation is held in the memories N2 and S2.

As illustrated in FIG. 15B, at the read timing ((M+2)H) of the (M+2)-th row, the control signal OFD transitions from the high level to the low level, and the reset operation ends. At this time, the S-signal is held in the memory S0, and the N-signal is held in the memory N0. Then, the digital signals of the (M+2)-th row held in the memories N0 and S0 and the digital signals of the second row held in the memories N1 and S1 are input to the signal processing circuit 28. The signal processing circuit 28 performs correction processing using these digital signals to reduce the influence of noise generated by the end of the reset operation.

As illustrated in FIG. 15B, at the read timing ((N−3)H) of the (N−3)-th row, the control signal TX1 transitions from the low level to the high level, and further transitions from the high level to the low level, whereby the start and end of the transfer operation are performed. At this time, the S-signal is held in the memory S0, and the N-signal is held in the memory N0. Then, the digital signals of the (N−3)-th row held in the memories N0 and S0 and the digital signals of the third row held in the memories N2 and S2 are input to the signal processing circuit 28. The signal processing circuit 28 performs correction processing using these digital signals to reduce the influence of noise generated by the start and end of the transfer operation. As described above, noise may occur due to both the start and end of the transfer operation in one readout period, and such noise can be corrected in the modification. In addition, noise may occur due to both the start and end of the reset operation in one readout period. Even in such a case, such noise can be corrected by the same driving method as in the modification.

### Third Embodiment

In the embodiment, a modification in which a plurality of column circuits share the memories N1 and S1 with respect to the first embodiment will be described. In the embodiment, description of elements common to those of the first embodiment may be omitted or simplified.

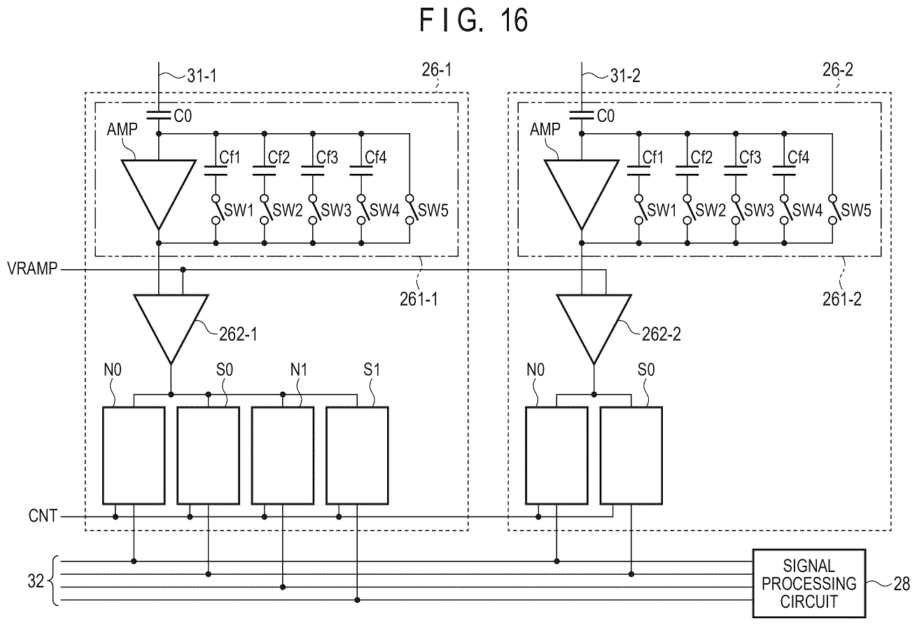

FIG. 16 is a diagram illustrating an equivalent circuit of the column circuit 26 according to the embodiment. FIG. 16 illustrates column circuits 26-1 and 26-2. Signals are input to the column circuits 26-1 and 26-2 via two adjacent vertical output lines 31-1 and 31-2. The column circuit 26-1 includes a column amplifier 261-1, a comparator 262-1, and memories N0, S0, N1, and S1. The column circuit 26-2 includes a column amplifier 261-2, a comparator 262-2, and memories N0 and S0. The column circuit 26-1 has the same circuit configuration as the column circuit 26 of FIG. 7. The memories N1 and S1 of the column circuit 26-1 are also shared by the column circuit 26-2. That is, the column circuit 26-2 has a circuit configuration in which the memories N1 and S1 are omitted from the column circuit 26 of FIG. 7.

As described above, in the embodiment, the occupied area of the column circuit can be reduced as compared with the case where the memories N1 and S1 are arranged in the column circuit of each column. In addition, since the number of memories arranged can be reduced, power required for operation of the memories such as data transfer can be reduced. Therefore, according to the embodiment, in addition to the same effects as those of the first embodiment, a photoelectric conversion device capable of realizing a reduction in element area or a reduction in power consumption is provided.

Signal transfer from the memories N0, S0, N1, and S1 of the column circuit 26-1 and the memories N0 and S0 of the column circuit 26-2 to the signal processing circuit 28 can be performed, for example, as follows. The memories N1 and S1 of the column circuit 26-1 may output signals when the memories N0 and S0 of the column circuit 26-1 output signals, and the memories N1 and S1 of the column circuit 26-1 may also output signals when the memories N0 and S0 of the column circuit 26-2 output signals.

Alternatively, while the memories N1 and S1 of the column circuit 26-1 output signals when the memories N0 and S0 of the column circuit 26-1 output signals, the memories N1 and S1 of the column circuit 26-1 may not output signals when the memories N0 and S0 of the column circuit 26-2 output signals. In this case, the signal processing circuit 28 may hold the signals output from the memories N1 and S1 of the column circuit 26-1 and use the signals for processing the output signals from the column circuit 26-2.

The circuit configuration related to the sharing of the memories N1 and S1, the number of column circuits shared by the memories N1 and S1, the signal transfer method between the column circuits and the signal processing circuit, and the like are not limited to those described above. For example, in one embodiment, only the memory N1 may be shared by a plurality of column circuits, or only some bits of the memory N1 may be shared by a plurality of column circuits. In the configuration in which the column circuit includes the memories N1, S1, N2, and S2 as illustrated in FIG. 12, one of the memories N1 and S1 or the memories N2 and S2 may be shared by a plurality of column circuits. The memory sharing method can be appropriately designed in consideration of the influence of noise reduction by the correction processing, the distribution of noise in the row, the element area, and the like. The signal transfer method between the column circuit and the signal processing circuit can be appropriately designed in consideration of the amount of data of a signal to be transmitted, power consumption, and the like.

### Fourth Embodiment

In the embodiment, a modification in which the driving method and the signal processing method are modified from those in the second embodiment will be described. In the embodiment, description of elements common to those of the second embodiment may be omitted or simplified.

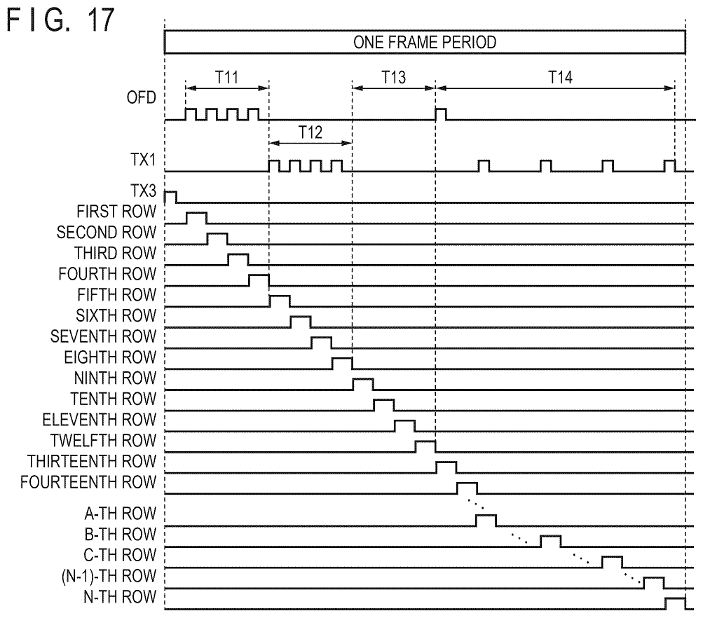

FIG. 17 is a drive timing chart of the photoelectric conversion device according to the embodiment. FIG. 17 illustrates the timings of the potential change of the control signals OFD, TX1, and TX3 and the timing of the readout of each row in one frame period.

In a period T11, the reset operation corresponding to the reset operation in the period TD in FIG. 10 is performed four times in the readout period of four rows from the first row to the fourth row. In a period T12, the transfer operation corresponding to the transfer operation in the period TG in FIG. 10 is performed four times in the readout period of four rows from the fifth row to the eighth row. A period T13 is a readout period for four rows from the ninth row to the twelfth row, and the reset operation and the transfer operation are not performed in the period T13. A period T14 corresponds to a period after the time t11 in FIG. 10, and the charge accumulation and transfer operations are performed in the period T14.

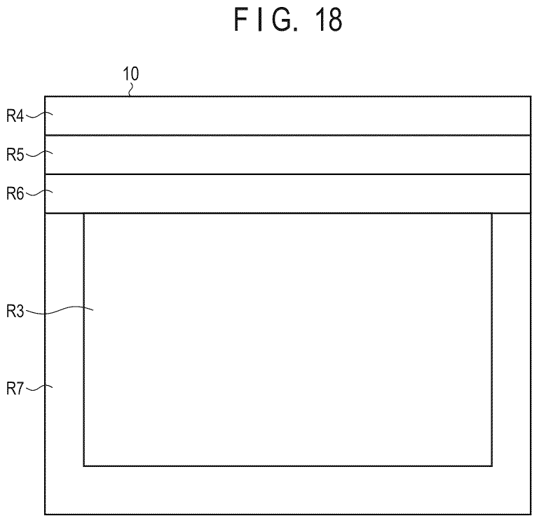

FIG. 18 is a diagram illustrating regions in the pixel array 10 according to the embodiment. The pixel array 10 includes an effective pixel region R3 and OB pixel regions R4, R5, R6, and R7. Effective pixels that output signals based on incident light are arranged in the effective pixel region R3, and OB pixels configured to prevent light from entering the photoelectric conversion unit PD are arranged in the OB pixel regions R4, R5, R6, and R7. The first row to the fourth row in FIG. 17 correspond to the OB pixel region R4. The fifth row to the eighth row in FIG. 17 correspond to the OB pixel region R5. The ninth row to the twelfth row in FIG. 17 correspond to the OB pixel region R6. The thirteenth row to the N-th row in FIG. 17 correspond to the effective pixel region R3.

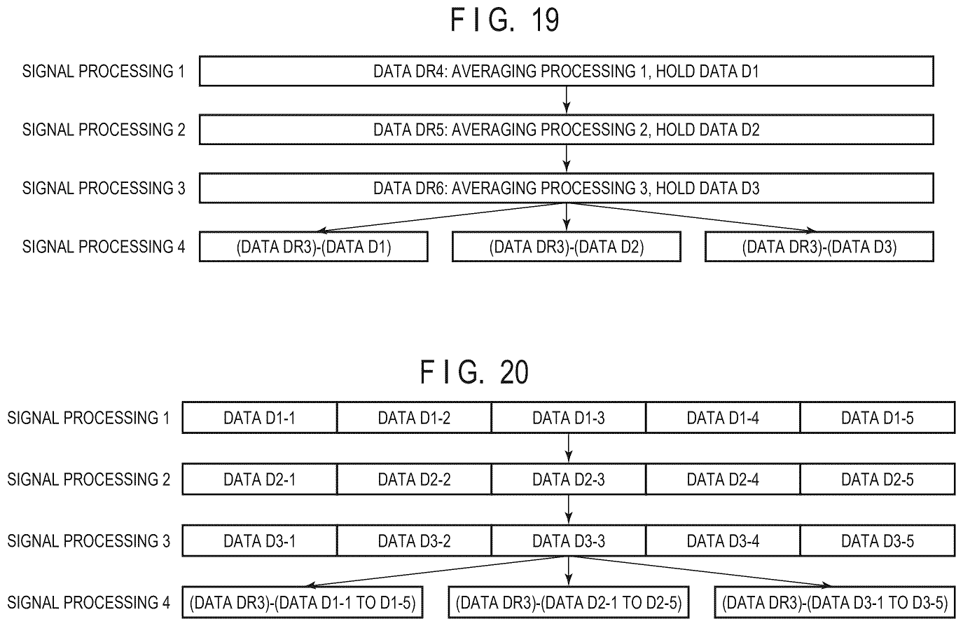

FIG. 19 is a diagram illustrating a procedure of signal processing according to the embodiment. FIG. 19 schematically illustrates a procedure of four-stage signal processing (signal processing 1 to signal processing 4) for acquiring signals from the effective pixel region R3 based on signals acquired from the OB pixel regions R4, R5, and R6. The signal processing may be performed in the column circuit 26, may be performed in the signal processing circuit 28, or may be performed in a signal processing device outside the photoelectric conversion device.

It is assumed that the signals read from the OB pixel regions R4, R5, and R6 are held in the memory in advance as data DR4, DR5, and DR6. Since the data DR4 is read during the reset operation in the period T11, the data DR4 includes information on noise generated by the reset operation. Since the data DR5 is read during the transfer operation in the period T12, the data DR5 includes information on noise generated by the transfer operation. Since the data DR6 is read without performing the reset operation and the transfer operation in the period T13, the data DR6 does not include information on noise generated by the reset operation and the transfer operation. The memory may be arranged in the column circuit 26, may be arranged in the signal processing circuit 28, or may be arranged outside the photoelectric conversion device.

In the signal processing 1, averaging of data DR4 obtained from a plurality of pixels in the OB pixel region R4 is performed (averaging processing 1). Then, the averaged data D1 is held in the memory. In the signal processing 2, averaging of data DR5 obtained from a plurality of pixels in the OB pixel region R5 is performed (averaging processing 2). Then, the averaged data D2 is held in the memory. In the signal processing 3, averaging of data DR6 obtained from a plurality of pixels in the OB pixel region R6 is performed (average processing 3). Then, the averaged data D3 is held in the memory. The averaging processing may be performed on data from a plurality of pixels in one column, or may be performed on data from a plurality of pixels in a block that is a region including a plurality of columns. The signal processing 1, the signal processing 2, and the signal processing 3 may be performed sequentially as illustrated in FIG. 19, or may be performed in parallel. Although averaging is exemplified as the arithmetic processing performed in the signal processing 1, the signal processing 2, and the signal processing 3, other statistical processing may be performed. This arithmetic processing may be, for example, processing of accumulating data obtained from a plurality of pixels.

In the signal processing 4, correction processing using the data D1 to D3 is performed on the data DR3 obtained from a plurality of pixels in the effective pixel region R3. Processing of subtracting the data D1 from the data DR3 is performed on the data DR3 obtained from a plurality of pixels in a row (the thirteenth row in FIG. 17) in which the readout timing overlaps the reset operation in the effective pixel region R3. Processing of subtracting the data D2 from the data DR3 is performed on the data DR3 obtained from a plurality of pixels in a row (an A-th row, a B-th row, a C-th row, and the N-th row in FIG. 17) in which the readout timing overlaps the transfer operation in the effective pixel region R3. Processing of subtracting the data D3 from the data DR3 is performed on the data DR3 obtained from a plurality of pixels in a row in which the readout timing does not overlap with any of the reset operation and the transfer operation in the effective pixel region R3. These three types of correction processing may be performed in parallel as illustrated in FIG. 19 or may be performed sequentially. By the signal processing, it is possible to suitably reduce noise such as an offset component of each row and an offset component of each column of the pixel array 10.

According to the embodiment, a photoelectric conversion device capable of reducing the influence of noise generated by the global electronic shutter operation is provided. Further, in the embodiment, since the reset operation and the transfer operation are performed a plurality of times in the OB pixel region, a plurality of pieces of correction data can be generated, and the influence of noise can be reduced more suitably.

In the example described above, the averaging in the generation of the data D1, D2, and D3 may be performed on data from a plurality of pixels in one block that is a region including a plurality of columns. FIG. 20 is a diagram illustrating a modification of the procedure of the signal processing according to the embodiment. FIG. 20 illustrates an example in which the pixel array 10 is divided into five blocks of column ranges and averaged.

In the signal processing 1, averaging similar to that of FIG. 19 is performed for each of the five blocks, and the data D1-1 to D1-5 are held. Similarly, the data D2-1 to D2-5 and the data D3-1 to D3-5 are held in the signal processing 2 and 3. In the signal processing 4, similarly to FIG. 19, processing of subtracting the data D1-1 to D1-5, the data D2-1 to D2-5, and the data D3-1 to D3-5 from the data DR3 is performed for each block.

Although FIG. 20 illustrates an example in which the number of blocks is five, the same processing can be performed as long as the number of blocks is two or more. When the pixel array 10 includes a first block and a second block, the following processing is performed. For the signals from the pixels of the first block, the data D1-1, D2-1, and D3-1 are held by the signal processing 1, 2, and 3 (first processing). For the signals from the pixels of the second block, the data D1-2, D2-2, and D3-2 are held by the signal processing 1, 2, and 3 (second processing). Then, in the signal processing 4, similarly to FIG. 19, processing of subtracting the data D1-1, D1-2, D2-1, D2-2, D3-1, and D3-2 from the data DR3 is performed for each block.

In the configuration in which the data of the signal processing 1, 2, and 3 are held for each block as illustrated in FIG. 20, arithmetic processing using a predetermined function may be performed on the data of a plurality of blocks. An example of this arithmetic processing is interpolation processing.

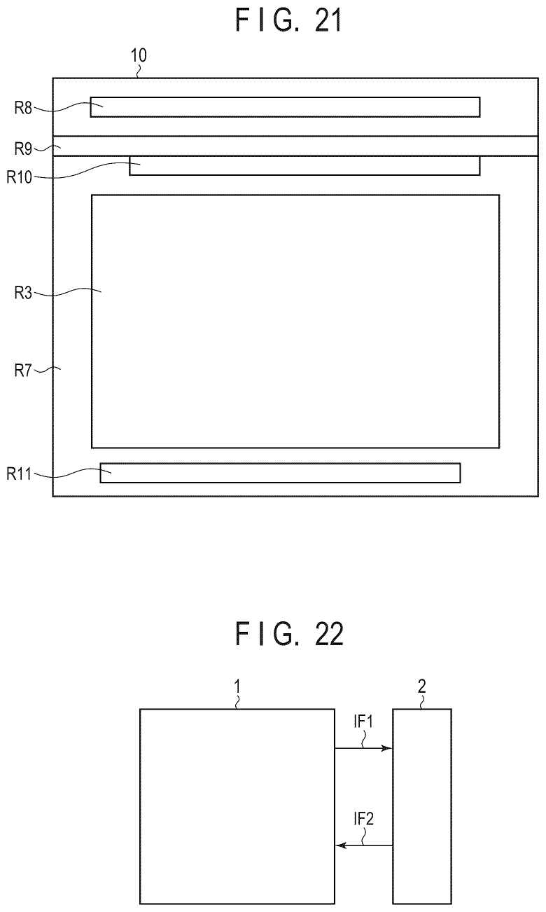

A modification of the method of dividing the OB pixel region will be described. FIG. 21 is a diagram illustrating a modification of the regions in the pixel array 10 according to the embodiment. The pixel array 10 includes an effective pixel region R3 and OB pixel regions R7, R8, R9, R10, and R11. Each of the OB pixel regions R7, R8, R9, R10, and R11 may be a pixel region driven in the same manner as any of the OB pixel regions R4, R5, and R6 in FIG. 18.

The OB pixel regions R4, R5, and R6 in FIG. 18 are arranged so as to be continuously read. However, the OB pixel region may be arranged so as to be discontinuously read at the time of reading, as in the OB pixel regions R8, R10, and R11 in FIG. 21. The OB pixel regions R4, R5, and R6 in FIG. 18 are arranged so as to include all the columns of the pixel array 10. However, the OB pixel region may be arranged so as to include a part of all the columns of the pixel array 10 as in the OB pixel regions R8, R10, and R11 of FIG. 21. The positions, ranges, and the like of the OB pixel regions may be determined according to the output characteristics of the pixels of the pixel array 10. When each of the signal processing 1, 2, and 3 is performed, data from a plurality of OB pixel regions may be used in combination.

### Fifth Embodiment

In the embodiment, a modification in which correction processing is performed outside the photoelectric conversion device of the above-described embodiment will be described. In the embodiment, description of elements common to the above-described embodiments may be omitted or simplified.

FIG. 22 is a diagram illustrating a photoelectric conversion device 1 and a signal processing device 2 according to the embodiment. The system illustrated in FIG. 22 includes the photoelectric conversion device 1 and the signal processing device 2. The photoelectric conversion device 1 corresponds to the photoelectric conversion device illustrated in the above-described embodiments. However, in the photoelectric conversion device 1 of the embodiment, the correction processing is performed outside the photoelectric conversion device 1. The signal processing device 2 processes the digital signals generated by the photoelectric conversion device 1. The signal processing device 2 may be an image signal processor.

The photoelectric conversion device 1 and the signal processing device 2 are communicably connected by an output interface IF1 and a control interface IF2. The digital signals output from the photoelectric conversion device 1 are input to the signal processing device 2 via the output interface IF1. The signal processing device 2 processes the digital signals output from the photoelectric conversion device 1. The signal processing device 2 may generate setting data based on the digital signals output from the photoelectric conversion device 1 and output the setting data to the photoelectric conversion device 1. In this case, the photoelectric conversion device 1 may perform processing according to the setting data.

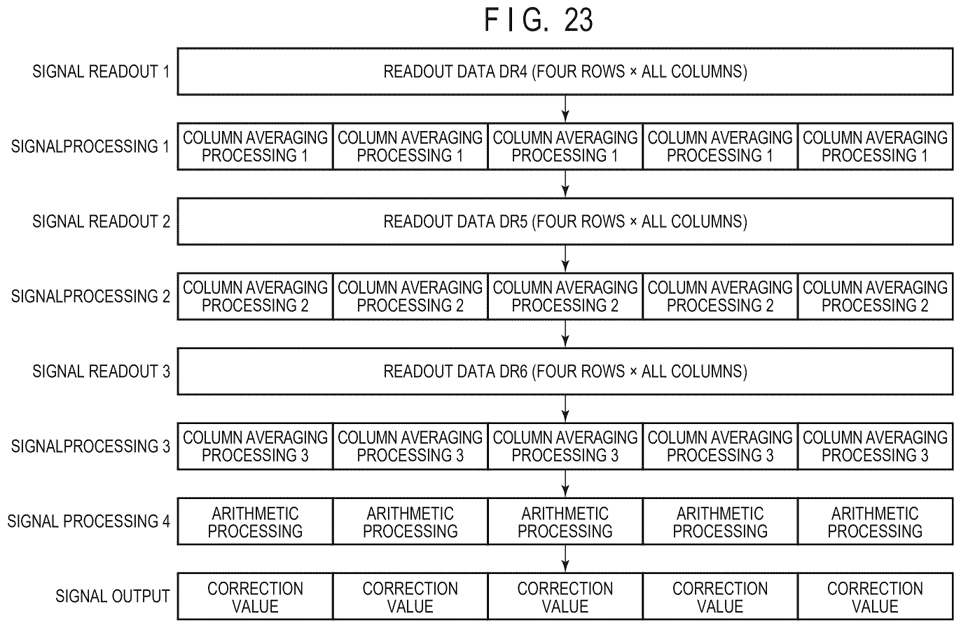

A specific example of signal processing performed in the photoelectric conversion device 1 and the signal processing device 2 will be described. FIG. 23 is a diagram illustrating a procedure of signal processing according to the embodiment. In the signal processing of FIG. 23, it is assumed that the pixel region in the pixel array 10 is set as illustrated in FIG. 18 of the fourth embodiment. Further, as in the fourth embodiment, it is assumed that the number of rows in each of the OB pixel regions R4, R5, and R6 is four.

The photoelectric conversion device 1 performs three-stage signal readout (signal readout 1 to signal readout 3). The signal processing device 2 receives the digital signals read from the photoelectric conversion device 1, performs four-stage signal processing (signal processing 1 to signal processing 4), and outputs signals to the photoelectric conversion device 1.

In the signal readout 1, the photoelectric conversion device 1 outputs data DR4 obtained from a plurality of pixels (four rows×all columns) in the OB pixel region R4 to the signal processing device 2. The data DR4 includes information on noise generated by the reset operation. In the signal processing 1, the signal processing device 2 performs averaging on the data DR4 for each block in the five column ranges (column averaging processing 1).

In the signal readout 2, the photoelectric conversion device 1 outputs data DR5 obtained from a plurality of pixels (four rows×all columns) in the OB pixel region R5 to the signal processing device 2. The data DR5 includes information on noise generated by the transfer operation. In the signal processing 2, the signal processing device 2 performs averaging on the data DR5 for each block in the five column ranges (column averaging processing 2).

In the signal readout 3, the photoelectric conversion device 1 outputs data DR6 obtained from a plurality of pixels (four rows×all columns) in the OB pixel region R6 to the signal processing device 2. The data DR6 does not include information on noise generated by the reset operation and the transfer operation. In the signal processing 3, the signal processing device 2 performs averaging on the data DR6 for each block in the five column ranges (column averaging processing 3).

In the signal processing 4, the signal processing device 2 performs arithmetic processing based on the averaged data obtained in the signal processing 1, the signal processing 2, and the signal processing 3, and calculates correction values. Then, the signal processing device 2 outputs the correction values to the photoelectric conversion device 1. This arithmetic processing is also performed for each block in the five column ranges. This arithmetic processing may include, for example, processing of detecting the influence of noise generated by the reset operation or the transfer operation. For example, the influence of noise caused by the reset operation can be detected from a difference between the data obtained by the column averaging processing 3 and the data obtained by the column averaging processing 1. Further, for example, the influence of noise caused by the transfer operation can be detected from a difference between the data obtained by the column averaging processing 3 and the data obtained by the column averaging processing 2.

The photoelectric conversion device 1 may perform arithmetic processing based on the correction values input from the signal processing device 2. For example, the signal processing circuit 28 of the photoelectric conversion device 1 may perform arithmetic processing such as gain processing and offset addition processing on the digital signals read from the pixels 11 in the effective pixel region based on the correction values, and output the processed digital signals.

According to the embodiment, a photoelectric conversion device capable of reducing the influence of noise generated by the global electronic shutter operation is provided. Further, in the embodiment, correction processing may be performed in a signal processing device outside the photoelectric conversion device. As a result, it is possible to increase the functionality of the photoelectric conversion device while maintaining the occupied area of the photoelectric conversion device.

### Sixth Embodiment

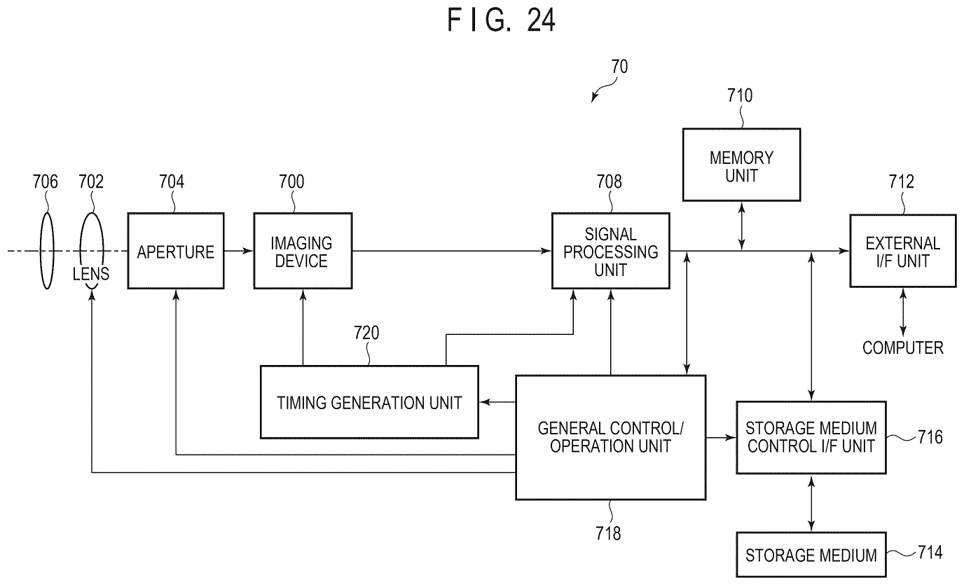

The photoelectric conversion device of the above embodiments can be applied to various equipment. Examples of the equipment include a digital still camera, a digital camcorder, a camera head, a copying machine, a facsimile, a mobile phone, a vehicle-mounted camera, an observation satellite, and a surveillance camera. FIG. 24 is a block diagram of a digital still camera as an example of equipment.

The equipment 70 illustrated in FIG. 24 includes a barrier 706, a lens 702, an aperture 704, and an imaging device 700 (an example of the photoelectric conversion device). The equipment 70 further includes a signal processing unit (processing device) 708, a timing generation unit 720, a general control/operation unit 718 (control device), a memory unit 710 (storage device), a storage medium control I/F unit 716, a storage medium 714, and an external I/F unit 712. At least one of the barrier 706, the lens 702, and the aperture 704 is an optical device corresponding to the equipment. The barrier 706 protects the lens 702, and the lens 702 forms an optical image of an object on the imaging device 700. The aperture 704 varies the amount of light passing through the lens 702. The imaging device 700 is configured as in the above embodiments, and converts an optical image formed by the lens 702 into image data (image signal). The signal processing unit 708 performs various corrections, data compression, and the like on the image data output from the imaging device 700. The timing generation unit 720 outputs various timing signals to the imaging device 700 and the signal processing unit 708. The general control/operation unit 718 controls the entire digital still camera, and the memory unit 710 temporarily stores image data. The storage medium control I/F unit 716 is an interface for storing or reading image data on the storage medium 714, and the storage medium 714 is a detachable storage medium such as a semiconductor memory for storing or reading image data. The external I/F unit 712 is an interface for communicating with an external computer or the like. The timing signal or the like may be input from the outside of the equipment. The equipment 70 may further include a display device (a monitor, an electronic view finder, or the like) for displaying information obtained by the photoelectric conversion device. The equipment includes at least a photoelectric conversion device. Further, the equipment 70 includes at least one of an optical device, a control device, a processing device, a display device, a storage device, and a mechanical device that operates based on information obtained by the photoelectric conversion device. The mechanical device is a movable portion (for example, a robot arm) that receives a signal from the photoelectric conversion device for operation.

Each pixel may include a plurality of photoelectric conversion units (a first photoelectric conversion unit and a second photoelectric conversion unit). The signal processing unit 708 may be configured to process a pixel signal based on charges generated in the first photoelectric conversion unit and a pixel signal based on charges generated in the second photoelectric conversion unit, and acquire distance information from the imaging device 700 to an object.

### Seventh Embodiment

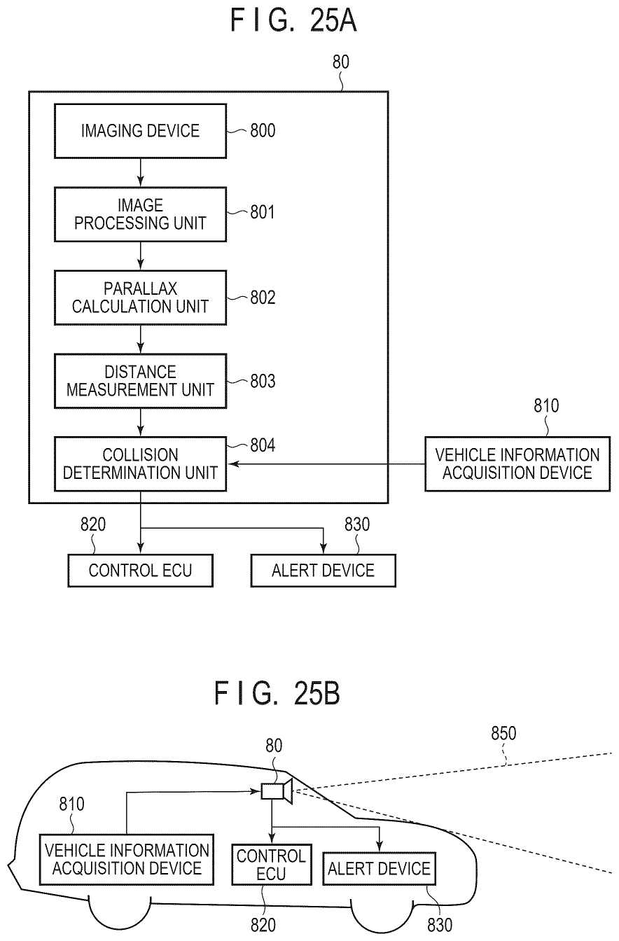

FIGS. 25A and 25B are block diagrams of equipment relating to the vehicle-mounted camera according to the embodiment. The equipment 80 includes an imaging device 800 (an example of a photoelectric conversion device) of the above embodiments and a signal processing device (processing device) that processes a signal from the imaging device 800. The equipment 80 includes an image processing unit 801 that performs image processing on a plurality of pieces of image data acquired by the imaging device 800, and a parallax calculation unit 802 that calculates parallax (phase difference of parallax images) from the plurality of pieces of image data acquired by the equipment 80. The equipment 80 includes a distance measurement unit 803 that calculates a distance to an object based on the calculated parallax, and a collision determination unit 804 that determines whether or not there is a possibility of collision based on the calculated distance. Here, the parallax calculation unit 802 and the distance measurement unit 803 are examples of a distance information acquisition unit that acquires distance information to the object. That is, the distance information is information on a parallax, a defocus amount, a distance to the object, and the like. The collision determination unit 804 may determine the possibility of collision using any of these pieces of distance information. The distance information acquisition unit may be realized by dedicatedly designed hardware or software modules. Further, it may be realized by a field programmable gate array (FPGA), an application specific integrated circuit (ASIC) or a combination thereof.

The equipment 80 is connected to the vehicle information acquisition device 810, and can obtain vehicle information such as a vehicle speed, a yaw rate, and a steering angle. Further, the equipment 80 is connected to a control ECU 820 which is a control device that outputs a control signal for generating a braking force to the vehicle based on the determination result of the collision determination unit 804. The equipment 80 is also connected to an alert device 830 that issues an alert to the driver based on the determination result of the collision determination unit 804. For example, when the collision possibility is high as the determination result of the collision determination unit 804, the control ECU 820 performs vehicle control to avoid collision or reduce damage by braking, returning an accelerator, suppressing engine output, or the like. The alert device 830 alerts the user by sounding an alarm such as a sound, displaying alert information on a screen of a car navigation system or the like, or giving vibration to a seat belt or a steering wheel. The equipment 80 functions as a control unit that controls the operation of controlling the vehicle as described above.

In the embodiment, an image of the periphery of the vehicle, for example, the front or the rear is captured by the equipment 80. FIG. 25B illustrates equipment in a case where an image is captured in front of the vehicle (image capturing range 850). The vehicle information acquisition device 810 as the imaging control unit sends an instruction to the equipment 80 or the imaging device 800 to perform the imaging operation. With such a configuration, the accuracy of distance measurement can be further improved.

Although the example of control for avoiding a collision to another vehicle has been described above, the embodiment is applicable to automatic driving control for following another vehicle, automatic driving control for not going out of a traffic lane, or the like. Furthermore, the equipment is not limited to a vehicle such as an automobile and can be applied to a movable body (movable apparatus) such as a ship, an airplane, a satellite, an industrial robot and a consumer use robot, or the like, for example. In addition, the equipment can be widely applied to equipment which utilizes object recognition or biometric authentication, such as an intelligent transportation system (ITS), a surveillance system, or the like without being limited to movable bodies.

### Other Embodiments

The disclosure of this specification includes a complementary set of the concepts described in this specification. That is, for example, if a description of “A is B” (A=B) is provided in this specification, this specification is intended to disclose or suggest that “A is not B” even if a description of “A is not B” (A B) is omitted. This is because it is assumed that “A is not B” is considered when “A is B” is described.

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

It should be noted that the above-described embodiments are merely specific examples for implementing the disclosure, and the technical scope of the disclosure should not be construed as being limited thereto. That is, the disclosure can be implemented in various forms without departing from the technical idea or the main feature thereof.

According to the disclosure, a photoelectric conversion device capable of reducing the influence of noise generated by the global electronic shutter operation is provided.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2024-120289, filed Jul. 25, 2024, which is hereby incorporated by reference herein in its entirety.

What is claimed is:

1. A photoelectric conversion device comprising:
a pixel array in which a plurality of pixels are arranged to form a plurality of rows and a plurality of columns, each of the plurality of pixels including a charge accumulation unit configured to accumulate charge, a discharge transistor configured to perform a reset operation to discharge the charge accumulated in the charge accumulation unit, a holding unit configured to hold transferred charge, an amplification unit configured to output a signal based on the transferred charge, a first transfer transistor configured to transfer the charge from the charge accumulation unit to the holding unit, and a second transfer transistor configured to transfer the charge transferred by the first transfer transistor to the amplification unit; and
a scanning circuit configured to perform scanning for sequentially selecting a row in which the pixels output signals, from among the plurality of rows,
wherein a first pixel arranged in a first region of the pixel array outputs a signal based on incident light,
wherein a second pixel arranged in a second region of the pixel array does not output a signal based on incident light,
wherein in a period in which pixels in one row of the pixel array output signals, the reset operation by the discharge transistor is started or ended, and
wherein in a period from a start of one scan to a start of the next scan, number of times of the reset operation performed in the second pixel is greater than number of times of the reset operation performed in the first pixel.

2. The photoelectric conversion device according to claim 1, wherein the charge accumulation unit of the first pixel includes a photoelectric conversion element configured to generate and accumulate charge according to incident light.

3. The photoelectric conversion device according to claim 1, wherein the charge accumulation unit of the second pixel includes a photoelectric conversion element that is shielded from light.

4. The photoelectric conversion device according to claim 1, wherein the charge accumulation unit of the second pixel is a dummy element that does not include a photoelectric conversion element.

5. The photoelectric conversion device according to claim 1, wherein in a period in which pixels in one row of the pixel array output signals, the transfer of the charge by the first transfer transistor is started or ended.

6. The photoelectric conversion device according to claim 5, wherein in a period from a start of one scan to a start of the next scan, the charge is transferred a plurality of times in each of the first pixel and the second pixel.

7. The photoelectric conversion device according to claim 1, wherein in a period from a start of one scan to a start of the next scan, the reset operation is performed a plurality of times in each of the first pixel and the second pixel.

8. The photoelectric conversion device according to claim 1 further comprising a column circuit arranged corresponding to each of the plurality of columns and configured to process a signal output from a pixel in the corresponding column.

9. The photoelectric conversion device according to claim 1 further comprising a memory configured to hold a signal output from a pixel.

10. The photoelectric conversion device according to claim 8,
wherein the column circuit includes a memory configured to hold a signal output from a pixel in the corresponding column, and
wherein the memory holds a signal output from the first pixel in the corresponding column and a signal output from the second pixel in the corresponding column.

11. The photoelectric conversion device according to claim 8,
wherein the column circuit includes a memory configured to hold a signal output from a pixel in the corresponding column, and
wherein the memory holds a signal output from the first pixel in the corresponding column and signals output from two second pixels in the corresponding column.

12. The photoelectric conversion device according to claim 1, wherein correction processing of a signal output from the first pixel is performed based on a signal output from the second pixel.

13. The photoelectric conversion device according to claim 12, wherein correction processing of the signal output from the first pixel in a period in which the reset operation is performed is performed based on the signal output from the second pixel in a period in which the reset operation is performed.

14. The photoelectric conversion device according to claim 13, wherein correction processing of the signal output from the first pixel in a period including a timing at which the reset operation is started is performed based on the signal output from the second pixel in a period including a timing at which the reset operation is started.

15. The photoelectric conversion device according to claim 12, wherein the photoelectric conversion device outputs the signal output from the first pixel and the signal output from the second pixel to a signal processing device configured to perform the correction processing.

16. The photoelectric conversion device according to claim 15, wherein the photoelectric conversion device receives a correction value obtained by the correction processing from the signal processing device, and performs processing based on the correction value.

17. The photoelectric conversion device according to claim 12, wherein the correction processing includes processing of accumulating or averaging signals from a plurality of pixels.

18. The photoelectric conversion device according to claim 1,
wherein the pixel array is arranged in a first substrate, and
wherein processing of a signal output from each of the plurality of pixels is performed in a circuit arranged in a second substrate stacked on the first substrate.

19. Equipment comprising:
the photoelectric conversion device according to claim 1; and
at least any one of:
an optical device adapted for the photoelectric conversion device,
a control device configured to control the photoelectric conversion device,
a processing device configured to process a signal output from the photoelectric conversion device,
a display device configured to display information obtained by the photoelectric conversion device,
a storage device configured to store information obtained by the photoelectric conversion device, and
a mechanical device configured to operate based on information obtained by the photoelectric conversion device.

20. The equipment according to claim 19, wherein the processing device acquires distance information on a distance from the photoelectric conversion device to an object.
